(19) United States
(12) Patent Application Publication
(10) Pub. No.: US 2009/0173245 A1
(43) Pub. Date: Jul. 9, 2009

(54) Method for Manufacturing Screen Printing Mask With Resin and Screen Printing Mask With Resin

(76) Inventors: Munetoshi Irisawa, Tokyo (JP); Yuji Toyoda, Tokyo (JP); Yasuo Kaneda, Tokyo (JP); Kunihiro Nakagawa, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/226,000

(22) PCT Filed: Apr. 6, 2007
(86) PCT No.: PCT/JP2007/058211

§ 371 Date: Jan. 14, 2009

(30) Foreign Application Priority Data
Apr. 7, 2006 (JP) 2006-106066
Sep. 20, 2006 (JP) 2006-255090
Nov. 27, 2006 (JP) 2006-319299
Feb. 16, 2007 (JP) 2007-036886

(51) Int. Cl. B05C 17/06; B05D 1/32; C25D 5/02

(52) U.S. Cl. 101/128.21; 427/272; 205/122

(57) ABSTRACT

The method for making a screen printing mask, provided by this invention is a method for making a resin-formed screen printing mask having a resin layer on one main surface of a screen printing mask having openings, a resin layer having openings nearly in the same locations as those of said openings of the screen printing mask, and comprises the step of coating the one main surface of said screen printing mask with the resin layer by laminating, and the step of removing those parts of said resin layer which are positioned nearly in the same locations as those of the openings of said screen printing mask by self-alignment, to form the openings through the resin layer.

### TECHNICAL FIELD

This invention relates to a method for making a resin-formed screen printing mask and the resin-formed screen printing mask.

### BACKGROUND ART

With the downsizing and functional multiplication of electronic instruments in recent years, it is under way to attain the higher densification of electronic circuit boards and the finer wiring in interconnection patterns and it is widely practiced to mount electronic parts on an electronic circuit board in a high density. In this high-density mounting of electronic parts on an electronic circuit board, a cream solder is printed on the electronic circuit board surface for mounting electronic parts, electronic parts are placed on a solder terminal and the resultant set is heated in a reflow furnace to carry out soldering. As a method for printing the above cream solder, a step based on screen printing is widely used. In general, the screen printing refers to a method in which a screen printing mask having openings formed therein in the form of a pattern is set on the upper surface of a substrate on which a screen-printing mask is to be printed and a paste material such as a cream solder, etc., is supplied on the screen printing mask and squeezed with a squeegee, whereby the paste material is printed through the openings in the form of a pattern.

The screen printing mask includes, for example, an emulsion type screen printing mask (mesh mask), a metal mask, a solid mask, a suspended mask, etc.

As shown in FIG. 10, the emulsion type screen printing mask is obtained by applying a photosensitive emulsion 14 to a network-shaped mesh layer 13 composed of the weft 15a and the warp 15b and subjecting the photosensitive emulsion 14 to pattern exposure to form openings 2 for screen printing. The emulsion type screen printing mask can be easily made by pattern exposure and developing treatment.

The metal mask is obtained by forming openings corresponding to a printing pattern in/through a metal plate. The method for forming the openings includes an etching method, a laser method, an additive method, a machine processing method, etc.

FIG. 11 shows one example of a method for making a metal mask by an etching method. In this method, photosensitive resin layers 21 (FIG. 11(b)) are formed on both surfaces of a metal plate 10 (FIG. 11(a)), then, a photomask (not shown) having an open-hole pattern formed therein is stacked, and pattern exposure and developing treatment are carried out to expose metal plate surface corresponding to openings (FIG. 11(c)). Then, metal plate 10 in the openings is removed by etching treatment using remaining photosensitive resin layer 21 as etching resist 22 (FIG. 11(d)). Then, the etching resist 22 is removed to make a screen printing mask 1 having openings 2 (FIG. 11(e)). The etching method has an advantage that it can be carried out at a low cost since a screen printing mask can be made by pattern exposure, developing treatment and etching treatment.

FIG. 13 shows one example of a method for making a metal mask by a laser method. In this method, desired openings 2 are directly formed through a metal plate 10 (FIG. 13(a) by laser processing, to make a screen printing mask 1 (FIG. 13(b)). In the laser method, processing can be carried out directly on the basis of design data without using a photomask, so that it has an advantage that it enables the making for quick delivery.

FIG. 14 shows one example of a method for making a metal mask by an additive method (electroforming method). A plating resist layer 23 is formed on a base board 9 (FIG. 14(a)), and then a base board 9 surface that is not coated with the plating resist layer 23 is plated to form a plating metal layer 16 (FIG. 14(b)). Thereafter, the plating resist layer 23 and base board 9 are removed to obtain a screen printing mask 1 (FIG. 14(c)). The additive method requires time for carrying out its steps and is less productive and it also requires a high cost. However, a fine opening pattern can be formed and it is used in fields requiring high-precision printing such as a bump mask, etc.

The solid mask refers to a screen printing mask obtained by applying half etching treatment or additive plating treatment, etc., to a metal plate that is not opened and thereby forming a mesh pattern on one side of the metal plate and a pattern of openings on the other side.

The suspended mask refers to a screen printing mask obtained by applying additive plating treatment, or the like onto a plain-weaved mesh and thereby forming an opening pattern, and it is also sometimes made by attaching a metal plate having openings (i.e., a metal mask) onto a plain-weaved mesh.

Thanks to a metal plate that is used for making the metal mask, the solid mask and the suspended mask, they are excellent in dimensional stability as compared with the emulsion type screen printing mask.

With the recent higher-density mounting of electronic parts on an electronic circuit board, screen printing is also required to perform the printing of a higher-density and higher-precision pattern. However, some of conventional screen printing masks have sometimes failed to enable transfer-printing of a proper transfer amount of a paste material for a high-density and high-precision pattern without any passing failure.

For example, the emulsion type screen printing mask (FIG. 10(b)) has a problem that when a photosensitive emulsion 14 having a large layer thickness is used, the mesh layer 13 causes irregular reflection during pattern exposure to decrease the resolution of a pattern. It is therefore required to decrease the layer thickness of the photosensitive emulsion 14 for printing a high-density and high-precision pattern. On the other hand, when the volume of the openings 2 of a screen printing mask is increased, the transfer amount of a paste material can be increased, and when the size of a printing pattern (area of openings of a screen printing mask) is fixed, therefore, it is required to increase the layer thickness of the screen printing mask in order to increase the transfer amount. When the layer thickness of the photosensitive emulsion 14 is decreased for high-density and high-precision printing, therefore, the layer thickness of the emulsion type screen printing mask also decreases, and a sufficient amount of a paste material cannot be transfer-printed.

In the metal mask (FIG. 11(e)) made by an etching method, both of the surfaces of a metal plate are etched. When the cross-sectional form of an opening is closely observed, an opening is tapered and comes to have a convex form in its middle portion as shown in FIG. 12, which causes a passing failure of a paste material during printing. This problem becomes clear when the thickness of the metal plate 10 is increased or when the opening 2 comes to be finer. There is hence a condition that it is required to decrease the thickness of the metal plate 10 for a use in high-density and high-precision pattern printing, and a sufficient transfer amount of a paste material sometimes cannot be obtained. Further, when the thickness of the photosensitive resin layer 21 is too large, the spreadability of an etching solution is poor and the etching treatment is hence degraded in uniformity, so that the mask obtained also has a problem that it has a poor product quality as a screen printing mask.

In the metal mask made by a laser method (FIG. 13(b)), if laser processing is not carried out under optimum conditions taking account of the material quality, plate thickness, etc., of the metal plate 10, the flatness and smoothness of inner wall surface of each opening 2 are degraded, a passing failure of a paste material takes place and a high-density and high-precision printing pattern can be no longer dealt with. Further, when processing conditions are not suitable, there has been also caused a problem that the form per se of the openings 2 deviate from design data. Further, when laser processing could be carried out under optimum conditions, a polishing step such as mechanical polishing, electrolytic polishing, chemical polishing, etc., is required for removing burs formed during the laser processing and flattening/smoothening the surface of a mask when the mask is used for printing a higher-density and higher-precision pattern, and such takes time and labor.

As described above, for the purpose of transfer-printing a suitable transfer amount of a paste material for a high-density and high-precision pattern without any passing failure, there is demanded a screen printing mask that has high flatness and smoothness of inner wall surface of each opening, that has a fine opening form corresponding to a high-density and high-precision pattern and that has a large thickness.

Meanwhile, when a printing pattern has a high density and high precision, the contact between a screen printing mask and a substrate becomes important. When a gap is formed between a screen printing mask and a substrate, a paste material flows out from an opening pattern during printing, and bleeding takes place. FIG. 15 is a conceptual view showing a case where excellent printing is conducted in a screen printing step. FIG. 16 is a conceptual view showing a case where bleeding takes place in a screen printing step due to an contact failure caused by the concavoconvex form of a substrate. FIGS. 15(a) and 16(a) show states during printing. A screen printing mask 1 is stacked on a substrate 5 and a paste material 8 is placed thereon and then squeezed with a squeegee 7 thereby to transfer-print paste material 8 on the substrate 5 through an opening of the screen printing mask 1. In FIG. 15(b), the paste material 8 filled in the opening of the mask 1 is transferred as it has been since the surface of the substrate 5 has good flatness, and excellent printing is conducted. In FIG. 16(b), the bleeding of the paste material 8 takes place since the surface of the substrate 5 has poor flatness. When the bleeding takes place like this, there is increased the possibility of causing defects such as a bridged short-cut of adjacent patterns, etc., and as a result, no good-quality printing can be conducted.

For overcoming the above contact problem, there has been proposed a resin-formed screen printing mask in which a resin layer is formed on that surface of a screen printing mask which is to be in contact with a substrate. FIG. 17 shows screen printing steps using a resin-formed screen printing mask. Since a resin layer 3 is provided on the contact surface of a screen printing mask 1 to a substrate 5 as shown in FIG. 17(a), a resin-formed screen printing mask 4 intimately adheres to the substrate 5 having poor surface flatness, so that the bleeding of a paste material 8 is prevented. Therefore, excellent transfer-printing of the paste material 8 can be conducted (FIG. 17(b)).

In particular, screen printing masks such as a metal mask, a solid mask and a suspended mask are poor in contact to a substrate as compared with an emulsion type screen printing mask since the contact surface of each to a substrate is formed of a metal, and they have a problem that defects such as bleeding are likely to occur depending upon the kind of a substrate, the density of a pattern, the rigidity of each screen printing mask, etc.

As an example of a resin-formed screen printing mask in which a resin layer is formed on a metal mask, there is known a screen printing mask obtained by making a metal mask by an etching method, forming a photosensitive resin layer by an application technique or the like, stacking a photomask having an opening pattern formed therein, carrying out pattern exposure, then carrying out developing treatment and thereby forming openings in the photosensitive resin layer (for example, see JP3-57697A and JP9-315026A). A mask obtained by the above method improves the contact to a substrate and makes an improvement to overcome the problems of bleeding, etc. However, it is difficult to accurately register the openings of a metal mask and the opening pattern of a photomask, and positional deviation takes place in the openings of a metal mask and the openings of a photosensitive resin layer, so that there has been caused a problem that the printing position accuracy and transferability are poor.

As a method for making a resin-formed screen printing mask, there is known a method in which a metal mask having openings and a resin film having openings of the like pattern are attached to each other. In this method, however, positional deviation takes place as well when they are attached and there is caused a problem that the printing position accuracy and transferability are degraded (for example, see JP 54-10011A).

The above positional deviation in the opening of a screen printing mask and the opening of a resin layer from each other will be explained with reference to FIG. 18. FIG. 18(a) is a perspective view obtained by viewing a resin-formed screen printing mask 4 from a resin layer 3 surface, in which an edge portion 19 of opening 2 of a screen printing mask 1 and an edge portion 29 of opening 2 of the resin layer 3 are deviated from each other in position. A distance X represents the deviation of the position of centroid 18 of the opening 2 of the screen printing mask 1 and the position of centroid 28 of the opening of the resin layer 3 from each other. Further, FIG. 18(b) is a cross-sectional view of the resin-formed screen printing mask, obtained by cutting it along a line A-A′ in FIG. 18(a). When it has a cross-sectional form in which the openings 2 of the screen printing mask 1 and the resin layer 3 are so deviated from each other, a paste material cannot be printed in a proper position. Further, the opening 2 of the screen printing mask 1 is partially covered with a eaves of the resin layer 3, which results in a decrease in the transfer amount of a paste material.

There has been proposed a method for making a screen printing mask, in which the positional deviation in the openings of a screen printing mask and a resin layer from each other does not take place. As a first example, there has been disclosed a method in which the photosensitive resin layer 21 used as an etching resist 22 for making a metal mask by an etching method as shown in FIG. 11 is used intact as a resin layer without separating it (for example, see JP 6-96355B). In this method, the position of the opening 2 of the screen printing mask 1 is defined by the etching resist 22, so that the openings 2 of these two members are formed in almost like positions. Therefore, the problem of positional deviation in the openings is overcome. However, when this resin-formed screen printing mask is used for carrying out screen printing, the photosensitive resin layer 21 that has been once used as the etching resist 22 is liable to have abrasion and deformation, and there is caused a problem that the printing quality is degraded. Further, this method has a problem that it cannot be applied to any other method for making a screen printing mask than the etching method.

As a second example of the method for making a resin-formed screen printing mask in which the positional deviation in the openings of a screen printing mask and a resin layer from each other does not take place, there is disclosed a method in which a metal plate having no openings and a resin layer (e.g., a polyimide resin layer) having no openings are stacked and holes are made through both the resin layer and the metal plate simultaneously by laser processing with YAG laser, etc., (for example, see JP 2001-113667A). This method is free from the deviation of the positions of centroids of the openings of the metal plate and the resin layer, and openings can be accurately formed in like positions. It is also described that the opening width of the resin layer is made larger than the opening width of the metal plate by applying laser from the resin layer side so as to decrease the printing pressure (filling pressure) of a paste material in printing, and that there is produced an effect on an improvement to overcome the bleeding.

Due to the generation of heat during laser processing, however, the metal plate and the resin layer have thermal distortion or thermal deformation and the screen printing mask per se is sometimes distorted or the openings are sometimes deformed. Further, there is a case where the processing conditions for simultaneously making holes in the resin layer and the metal plate do not always correspond to the processing conditions for making holes in the metal plate alone. In such a case, holes are made in the metal plate under processing conditions different from optimum conditions, and the flatness and smoothness of inner wall surface of each opening of the metal plate are degraded, which sometimes cause problems such as the passing failure of a paste material, etc., during printing. Further, when the laser processing conditions are taken into account, the thickness of each of the metal plate and the resin layer is limited, and in some cases, a screen printing mask having an optimum plate thickness for screen printing cannot be made. That is, in the method for simultaneously making holes in the metal plate and the resin layer, it has been difficult to make openings stably and accurately.

As a third example of the method for making a resin-formed screen printing mask, in which the positional deviation in the openings of a screen printing mask and a resin layer from each other does not take place, there is disclosed a method in which a metal plate/resin layer laminated sheet is provided, the metal plate is first etched using a photosensitive resin layer and then resin layer corresponding to openings is removed (for example, see JP2005-144973A). In this method, the metal plate is etched from one side, so that the inner wall of each opening is more greatly tapered than a metal mask made by etching a metal plate from both surfaces as shown in FIG. 12, and there is sometimes caused the problem of passing failure of a paste material.

As a fourth example of the method for making a screen printing mask in which the positional deviation does not take place, there is known a method in which a resin layer containing a photo-decomposable resin is formed on a screen printing mask having openings, exposure is applied thereto through the openings from the opposite side and then developing treatment is carried out to remove resin layer in the openings (for example, see JP 8-258442A). In this method, it is difficult to apply the exposure to all the openings in parallel, and the positional deviation in the openings of the screen printing mask and the resin layer unavoidably takes place depending upon some positions of openings of the screen printing mask.

As a screen printing mask for a high-density and high-precision pattern such as a bump mask, etc., a metal mask made by the additive method is mainly used. In a metal mask according to the additive method, attempts are made to form a resin layer for improving its contact to a substrate, while the methods explained as the above first to fourth examples cannot be applied. That is, no resin layer could be formed on a metal mask made by the additive method without the positional deviation.

Moreover, the methods explained as the above first to fourth examples cannot be applied to a screen printing mask having a mesh layer in openings such as a suspended mask or a solid mask, and the improvement in the contact to a substrate by forming a resin layer without any positional deviation has not yet been accomplished.

In addition to the positional accuracy of the openings of the resin layer and the screen printing mask, preferably, the resin-formed screen printing mask can ensure that the plate thickness and the resin layer thickness of the screen printing mask can be independently optimized depending upon conditions such as the kind of a substrate, a printing pattern, the transfer amount of a paste material, and the like.

The methods for making resin-formed screen printing masks free of the positional deviation, explained in the above first to fourth examples, have a defect that they have no degree of freedom concerning the setting of a thickness. In the first example, for keeping the metal mask as much as possible from forming tapered inner wall surfaces of openings or for forming openings corresponding to a high-density and high-precision pattern, it is desirable to decrease both the thickness of the photosensitive resin layer and the thickness of the metal mask. In the second laser-processing example, the thickness of the metal plate and the thickness of the resin layer are limited depending upon laser processing conditions. In the third example, it is also required to decrease the thickness of the metal plate when the taper of openings of the metal mask is to be decreased. Further, when a screen printing mask is made from a laminated sheet formed of a metal plate and a resin layer, it is desirable to use commercially easily available laminated sheets, and in this case, the thickness of the metal plate and the thickness of the resin layer are limited. In the fourth example, it is required to decrease the thickness of the metal plate and the thickness of the resin layer for carrying out exposure by applying a sufficient dose of light to the photo-decomposable resin. That is, in the first to fourth examples, not only it is impossible to determine the thickness of the metal plate and the thickness of the resin layer as required, but also the total thickness of the resin layer and the metal mask in combination may be small in some cases. As a result, the transfer amount of a paste material has been sometimes insufficient.

Another requirement that the resin-formed screen printing mask is to satisfy is that the resin layer alone can be reproduced when the resin layer is partly broken off or damaged due to an increase in the number of printed products or the way of handling when screen printing is carried out repeatedly. In the first to third examples of the method for making a screen printing mask free of the positional deviation, the stacking of a metal plate and a resin layer is followed by the formation of openings in the metal plate, so that the resin layer alone cannot be reproduced, which necessitates making a screen printing mask again from the beginning, and it takes labor and time.

As described above, the resin-formed screen printing mask is required to satisfy the following requirements; There is to be no positional deviation in the openings of a screen printing mask and a resin layer, a resin layer can be formed on a screen printing mask of various kinds, the thickness of each of a screen printing mask and a resin layer are to be determined as required, and a resin layer that has been damaged can be easily reproduced. However, no conventional method for making a resin-formed screen printing mask could satisfy all of these requirements.

The problem involved in designing the form of openings of a screen printing mask will be explained below. The form of openings of a screen printing mask includes various forms such as a circular form, an elliptical form, a rectangular form, a pentagonal form, a hexagonal form, a heptangular form, an octagonal form, a gourd-shaped form, a dumbbell-shaped form, etc. For making a screen printing mask, it is required to prepare designed data, and it is more preferred to spend as little time as can be in the step of this data designing. Further, when a screen printing mask having rectangular openings of a high-density and high-precision pattern, in particular, like the printing of a solder terminal, etc., is made, a paste material poorly passes through corner portions of a rectangular form, so that the work of rounding the corners (i.e., increasing the curvature radius) is done in the step of data designing.

The processing of rounding the corner portions of an opening having a rectangular form in data designing will be explained with reference to FIG. 19. FIG. 19(a) shows the form of an opening 2 whose corner portions are rounded at a small curvature radius Rₐ. FIG. 19(b) shows the form of an opening 2 whose corner portions are rounded at a large curvature radius R_{b}. FIG. 20(a) shows a state of a screen printing mask 1 having the opening 2 shown in FIG. 19(a) after a paste material 8 has been screen-printed with the screen printing mask 1. FIG. 20(b) shows a state of a screen printing mask 1 having the opening 2 shown in FIG. 19(b) after a paste material 8 has been screen-printed with the screen printing mask 1.

When the opening 2 has a small curvature radius Rₐ, a paste material 8 lodges in the corner portions of the opening 2 of the screen printing mask 1 as shown in FIG. 20(a). There has been therefore involved a problem that no sufficient transfer amount of a paste material cannot be obtained or that when the screen printing is carried out repeatedly, the paste material 8 that has lodged in the corners is transferred at a time for some reason to cause abnormal transfer. When the opening 2 has a large curvature radius R_{b}, the logging of the paste material 8 is remedied as shown in FIG. 20(b) and the transfer amount is stabilized. However, there has been another problem that when the curvature radius is increased to excess, the area of the opening is too small and a sufficient transfer amount of a paste material can be no longer obtained. The data designing for rounding the corner portions has a problem that labor and time are taken before an optimum opening form can be determined.

### DISCLOSURE OF THE INVENTION

It is a first object of this invention to provide a method for making a resin-formed screen printing mask, which enables the excellent transfer-printing of a proper transfer amount of a paste material even for a high-density and high-precision pattern without bleeding or a passing failure, which is free of the positional deviation in the openings of a screen printing mask and a resin layer, which enables the formation of a resin layer on screen printing masks of various kinds, which permits setting of the thickness of each of a screen printing mask and a resin layer as required and which also permits the reproduction of a damaged resin layer alone.

It is a second object of this invention to provide a resin-formed screen printing mask having a form that enables the excellent transfer-printing of a proper amount of a paste material without any problems of bleeding, a passing failure and abnormal transfer even by simple data designing.

The present inventors have made diligent studies, and as a result it has been found that the above first object can be achieved by a method including the step of coating one main surface of a screen printing mask with a resin layer by laminating and the step of removing those parts of the above resin layer which are positioned nearly in the same locations as those of openings of the screen printing mask by self-alignment to form openings in/through the resin layer. It has been also found that the above second object is achieved by a resin-formed screen printing mask obtained by the above method. This invention has been completed on the basis of these that have been found.

That is, this invention provides

(1) a method for making a resin-formed screen printing mask having a resin layer on one main surface of a screen printing mask having openings, the resin layer having openings nearly in the same locations as those of said openings of the screen printing mask,

the method comprising the step of coating the one main surface of said screen printing mask with the resin layer by laminating, and

the step of removing those parts of said resin layer which are positioned nearly in the same locations as those of the openings of said screen printing mask by self-alignment, to form the openings through the resin layer,

(2) a method for making a resin-formed screen printing mask according to the above (1), wherein said screen printing mask having openings is one selected from a metal mask made by an additive method, a metal mask made by a laser method, a metal mask made by an etching method, a mesh mask, a suspended mask and a solid mask,

(3) a method for making a resin-formed screen printing mask according to the above (1), wherein said resin layer is formed from a photo-crosslinkable resin,

(4) a method for making a resin-formed screen printing mask according to the above (3), wherein the photo-crosslinkable resin contains (A) a carboxyl group-containing binder polymer, (B) a photopolymerizable compound having at least one polymerizable ethylenically unsaturated group in its molecule and (C) a photopolymerization initiator,

(5) a method for making a resin-formed screen printing mask according to the above (1), wherein said step of removing parts of the resin layer by self-alignment is practiced by supplying a resin layer-removing liquid from the other main surface that the screen printing mask has opposite to the main surface on which the resin layer is formed,

(6) a method for making a resin-formed screen printing mask according to the above (1), which further comprises the step of forming an electrodeposition resin layer on the resin layer after the step of coating one main surface of said screen printing mask with the resin layer but before the step of forming the openings through the resin layer,

wherein said electrodeposition resin layer is coated on the resin layer excluding those parts of said resin layer which are positioned nearly in the same locations as those of openings of said screen printing mask, and the step of removing parts of said resin layer by self-alignment is practiced by supplying a resin layer-removing liquid from the one main surface of said screen printing mask on which the resin layer and the electrodeposition layer are formed,

(7) a method for making a resin-formed screen printing mask according to the above (1), wherein the step of removing parts of said resin layer by self-alignment is practiced by supplying a resin layer-removing liquid after those parts of said resin layer which are positioned nearly in the same locations as those of openings of said screen printing mask are decreased in layer thickness,

(8) a method for making a resin-formed screen printing mask according to any one of the above (5) to (7), wherein the resin layer-removing liquid is an aqueous solution containing at least one selected from alkali metal carbonate, alkali metal phosphate, alkali metal hydroxide and alkali metal silicate,

(9) a method for making a resin-formed screen printing mask according to any one of the above (1) to (8), wherein the openings formed through the resin layer have a larger area than the openings of said screen printing mask,

(10) a method for making a resin-formed screen printing mask according to the above (9), wherein the resin-formed screen printing mask obtained is a resin-formed screen printing mask in which

the openings of the screen printing mask and the openings of the resin layer have nearly like forms,

the openings of the resin layer have a larger area than the openings of the screen printing mask, and

when a distance from an edge portion of opening of the screen printing mask to an edge portion of the resin layer in the vicinity of said opening is taken as an offset width, an offset width of a portion having a small curvature radius in the contour of opening of the screen printing mask is smaller than an offset width of a portion having a larger curvature radius in the contour of opening of the screen printing mask, and

(11) a resin-formed screen printing mask made by the method according to any one of the above (1) to (10).

The above first object can be achieved by the process for making a resin-formed screen printing mask, provided by this invention. The method of this invention comprises the step of coating the one main surface of the screen printing mask with the resin layer by laminating and the step of removing those parts of said resin layer which are positioned nearly in the same locations as those of openings of said screen printing mask by self-alignment, to form openings through the resin layer, and the resin layer of the openings is removed by self-alignment, so that this invention can accomplish an excellent effect that no positional deviation does not take place in the openings of the screen printing mask and the openings of the resin layer.

Further, according to the method of this invention, the screen printing mask having openings can be first made under optimum conditions, so that the resin layer can be formed on the screen printing mask excellent in flatness and smoothness of inner wall surface, dimensional accuracy of opening forms, and that the plate thickness of the screen printing mask can be set as required.

The resin layer is formed by laminating. Therefore, a laminate film having an arbitrary thickness is selected and the uniform thickness of the resin layer can be determined as required while inhibiting the occurrence of bleeding.

Further, the resin layer can be also formed on a screen printing mask that has been used without a resin layer. Therefore, when a screen printing mask that is once used for printing is further improved in contact for carrying out reprinting, or when the transfer amount of a paste material needs to be changed, it is not necessary to make a new screen printing mask. Similarly, the method of this invention also has an effect that the transfer amount can be post-adjusted by consecutively forming resin layers after trial printing with a screen printing mask made on an experimental basis. In addition thereto, when a resin layer portion is damaged, the resin layer portion alone can be reproduced without remaking a screen printing mask.

The above second object can be achieved by the resin-formed screen printing mask of this invention. Since the resin-formed screen printing mask of this invention is obtained by the method of this invention, it enables the excellent transfer-printing of a proper amount of a paste material without any problems of bleeding, a passing failure and abnormal transfer even by simple data designing.

### BRIEF EXPLANATION OF DRAWINGS

FIG. 1 shows cross-sectional views showing the method for making a resin-formed screen printing mask of this invention.

FIG. 2 shows cross-sectional views showing the method for making a resin-formed screen printing mask of this invention.

FIG. 3 shows cross-sectional views showing the method for making a resin-formed screen printing mask of this invention.

FIG. 4 shows drawings that explain a deviation in an opening of a screen printing mask and an opening of a resin layer in a resin-formed screen printing mask.

FIG. 5 shows drawings that explain an offset width of a resin-formed screen printing mask having a non-circular (rectangular) opening.

FIG. 6 is a cross-sectional view showing a step of screen printing.

FIG. 7 shows drawings that explain the resin-formed screen printing mask of this invention.

FIG. 8 is a cross-sectional view showing a step of screen printing.

FIG. 9 is a cross-sectional view showing a step of screen printing.

FIG. 10 shows cross-sectional views showing the steps of making an emulsion type screen printing mask.

FIG. 11 shows cross-sectional view showing steps of making a metal mask by an etching method.

FIG. 12 is a cross-sectional view of a metal mask made by an etching method.

FIG. 13 shows cross-sectional views showing the steps of making a metal mask by a laser method.

FIG. 14 shows cross-sectional views showing the steps of making a metal mask by an additive method.

FIG. 15 shows cross-sectional views showing the steps of screen printing.

FIG. 16 shows cross-sectional views showing the steps of screen printing.

FIG. 17 shows cross-sectional views showing the steps of screen printing with a resin-formed screen printing mask.

FIG. 18 are drawings that explain a deviation in the opening of a screen printing mask and the opening of a resin layer in a resin-formed screen printing mask.

FIG. 19 shows drawings that explain worked forms of non-circular (rectangular) openings.

FIG. 20 shows drawings that explain states of a paste material that remains in a non-circular (rectangular) opening after screen printing.

FIG. 21 shows drawings that explain a resin-formed screen printing mask according to a conventional method.

FIG. 22 shows drawings that explain a resin-formed screen printing mask according to a conventional method.

### BEST MODES FOR PRACTICING THE INVENTION

The method for making a resin-formed screen printing mask, provided by this invention, will be explained first.

The method for making a resin-formed screen printing mask, provided by this invention, is a method for making a resin-formed screen printing mask having a resin layer coated on one main surface of a screen printing mask having openings, the resin layer having openings nearly in the same locations as those of said openings of the screen printing mask,

the method comprising the step of coating the one main surface of said screen printing mask with the resin layer by laminating, and

the step of removing those parts of said resin layer which are positioned nearly in the same locations as those of openings of said screen printing mask by self-alignment, to form the openings through the resin layer.

The method of this invention will be explained below on the basis of an embodiment of the screen printing of a paste material such as a cream solder, etc., on an electronic circuit board, while it shall not be limited to the following embodiment unless it is contrary to the gist of this invention.

As a screen printing mask having openings in this invention, a screen printing mask made by any method can be used so long as it ensures that a paste material is placed on one surface thereof and that the paste material can be transferred to a substrate by scraping it up with a squeegee. There can be used any one of metal masks (made by an etching method, a laser method, an additive method, a mechanical processing method, etc.), an emulsion type screen printing mask (mesh mask), a solid mask, a suspended mask, etc.

In particular, when a metal mask made by an additive method is used as a screen printing mask, the formation of a resin layer on a metal mask made by an additive method, which formation has been so far difficult, can be excellently accomplished.

Further, when the screen printing mask is a metal mask made by a laser method, a resin layer having a desired thickness can be formed without any positional deviation after a metal mask is processed under optimum conditions by a laser method, so that resin-formed screen printing masks excellent in flatness and smoothness of inner walls of openings and form of the openings can be obtained without losing good productivity of screen printing masks by a laser method. Further, the treatment for flattening and smoothening a surface on which a resin layer is to be formed, such as a polishing treatment, etc., can be simplified.

Further, when the screen printing mask is a metal mask made by an etching method, even if a metal plate having a small plate thickness is used for etching a fine pattern, the thickness of a resin layer can be properly adjusted after the metal mask is made, whereby a desired transfer amount of a paste material can be obtained, and excellent resin-formed screen printing masks can be obtained while maintaining the advantage of being a low cost by the etching method.

When the screen printing mask is a screen printing mask having openings on a mesh layer such as a mesh mask, there are obviated ill effects that are caused by a mesh layer such as irregular reflection, etc., caused when a pattern exposure is applied, and a resin layer can be formed on the screen printing mask having openings without any positional deviation. Therefore, there can be obtained a resin-formed screen printing mask that is improved in contact and that enables the transfer-printing of a desired transfer amount of a desired paste material by properly adjusting the thickness of a resin layer.

The screen printing mask is preferably selected from screen printing masks formed of a metal such as nickel, copper, chromium, iron, etc., or alloys containing these metals as main components, and for example, a screen printing mask formed of stainless steel can be preferably used.

When the screen printing mask is that which has a mesh layer, the mesh includes metal mesh obtained by plain-weaving metal wires, resin mesh obtained by plain-weaving resin fibers, a product obtained by depositing a metal such as nickel, etc., in the form of a mesh by an additive method (electroforming method), mesh called a plated screen, obtained by plating any one of various plain-weaved meshes with a metal to fix points of intersection so that their dimensional stability is improved, and the like.

The screen printing mask generally has the form of a flat plate and may have the form of a flat plate formed of a single layer or laminate of the above metal or alloy. The screen printing mask preferably has a thickness of approximately 30 to 400 μm.

The form of the individual openings of the screen printing mask is not specially limited, and for example, it includes a circular form, an elliptical form, tetragonal forms such as a regular square, a rectangle, a rhombus, etc., polygonal forms including a pentagonal form and higher forms and other indeterminate forms such as a gourd-shaped form, a dumbbell-shaped form, etc. The size of each opening of the screen printing mask for general surface mounting is preferably several hundreds μm to several tens mm, and the above size for high-density mounting is preferably 30 to 300 μm. The pitch distance of the openings in high-density mounting is preferably 50 to 500 μm.

In the method of this invention, “laminating” means that a resin layer sheet (laminated film) formed beforehand in the form of a sheet is thermally press-bonded to a screen printing mask. When the resin layer is provided by the laminating, the adherence to a screen printing mask is secured, and no strain is caused in the screen printing mask by heat or pressure. As a method for the laminating, any method can be employed so long as the laminating can be performed with a uniform thickness, while it is preferred to carry out the laminating with a hot roll. The laminating temperature is preferably 40° C. to 150° C., more preferably 60° C. to 120° C. When the laminating is carried out with a hot roll, the pressure for press-bonding as a linear pressure is preferably 1 N/cm to 100 N/cm, more preferably 5 N/cm to 50 N/cm.

In the method of this invention, the resin layer is coated on one main surface of the screen printing mask having openings by the above laminating.

In the method of this invention, the resin for constituting the resin layer is not specially limited so long as it is a resin having the property of adhering to the screen printing mask, chemical strength and mechanical strength, while it is preferably a resin that is removable with a resin layer-removing liquid to be described later.

The above resin includes vinyl acetal resins such as an acrylic resin, an epoxy resin, a vinyl acetate resin, a vinyl chloride resin, a vinylidene chloride resin, a polyvinyl butyral resin, etc., polystyrene, polyethylene, polypropylene, chlorides thereof, polyester resins such as polyethylene terephthalate, polyethylene isophthalate, etc., and resins such as a polyamide resin, a vinyl modified alkyd resin, a phenolic resin, a xylene resin, a polyimide resin, gelatin and cellulose ester derivatives like carboxymethyl cellulose.

For imparting the resin layer with durability or mechanical strength against a paste material such as cream solder, etc., or wash liquid for the screen printing mask, the resin layer can be also constituted from a resin having curability with ultraviolet ray, etc., or heat-curability, and the resin layer is particularly preferably formed from a photo-crosslinkable resin. When the resin layer is constituted from a resin having ultraviolet curability or heat curability, treatment for durability can be efficiently applied by curing the resin layer by ultraviolet ray application after treatment for forming openings through/in the resin layer to be described later is carried out. In this manner, a high-durability resin-formed screen printing mask can be obtained.

As a photo-crosslinkable resin, any resin can be used so long as it is soluble in the resin layer-removing liquid to be described later and is cured after ultraviolet ray application to be capable of providing durability during screen printing. It preferably contains (A) a carboxyl group-containing binder polymer, (B) a photopolymerizable compound having at least one polymerizable ethylenically unsaturated group in its molecule and a photopolymerization initiator.

The carboxyl group-containing binder polymer (A) is not specially limited so long as it is a polymer that is photo-crosslinkable together with the photopolymerizable compound (B) having at least one polymerizable ethylenically unsaturated group in its molecule. For example, the binder polymer (A) includes organic polymers such as an acrylic resin, a methacrylic resin, a styrene resin, an epoxy resin, an amide resin, an amide epoxy resin, an alkyd resin and a phenolic resin, and these may be used singly or in combination. When an alkali aqueous solution is used as the resin layer-removing liquid to be described later, a (meth)acrylic resin is preferred since it is highly soluble in the resin layer-removing liquid.

The (meth)acrylic resin includes resins which have a constituting unit derived from (meth)acrylate, and examples of the (meth)acrylate constituting the above resin include methyl (meth)acrylate, ethyl (meth)acrylate, isopropyl (meth)acrylate, n-butyl (meth)acrylate, isobutyl (meth)acrylate, n-hexyl (meth)acrylate, 2-ethylhexyl (meth)acrylate, cyclohexyl (meth)acrylate, benzyl (meth)acrylate, 2-hydroxyethyl (meth)acrylate, hydroxypropyl (meth)acrylate, glycidyl (meth)acrylate, lauryl (meth)acrylate, tetrahydrofurfuryl (meth)acrylate, 2-(dimethylamino)ethyl (meth)acrylate, 2-(diethylamino)ethyl (meth)acrylate, 2,2,2-trifluoroethyl (meth)acrylate, 2,2,3,3-tetrafluoropropyl (meth)acrylate, etc.

Further, the carboxyl group-containing binder polymer (A) is more preferably a binder polymer having a polymerizable ethylenically unsaturated group in its molecule. The binder polymer having a polymerizable ethylenically unsaturated group in its molecule includes a binder polymer having constituting units derived from the above (meth)acrylate, an ethylenically unsaturated carboxylic acid and other polymerizable monomer.

Examples of the above ethylenically unsaturated carboxylic acid include monocarboxylic acids such as acrylic acid, methacrylic acid, crotonic acid, etc., dicarboxylic acids such as maleic acid, fumaric acid, itaconic acid, etc., and anhydrides and half esters of these. Of these, acrylic acid and methacrylic acid are particularly preferred. Further, examples of the above “other polymerizable monomer” include styrene, α-methylstyrene, p-methylstyrene, p-ethylstyrene, p-methoxystyrene, p-ethoxystyrene, p-chlorostyrene, p-bromostyrene, (meth)acrylonitrile, (meth)acrylamide, diacetoneacrylamide, vinyl toluene, vinyl acetate, vinyl-n-butyl ether, etc.

In the binder polymer having a polymerizable ethylenically unsaturated group, preferably, the double bond equivalent weight that shows a resin gram mass per mole of unsaturated group is 400 to 3,000. When the double bond equivalent weight is less than 400, the storage stability is liable to be degraded. When it exceeds 3,000, a large quantity of energy may be sometimes required during curing.

Further, the binder polymer having a polymerizable ethylenically unsaturated group in its molecule includes a product obtained by adding an alicyclic epoxy group-containing ethylenically unsaturated compound or an epoxy group-containing aliphatic ethylenically unsaturated compound to an acryl copolymer resin containing a constituting unit derived from the above (meth)acrylate ester, an ethylenically unsaturated carboxylic acid and other polymerizable monomer. The alicyclic epoxy group-containing ethylenically unsaturated compound and the epoxy group-containing aliphatic ethylenically unsaturated compound refer to compounds each of which contains one polymerizable unsaturated group and an alicyclic epoxy group or an aliphatic epoxy group per molecule. Specifically, there can be suitably used a copolymer resin obtained by adding glycidyl (meth)acrylate to a copolymer obtained from methyl methacrylate and acrylic acid and/or methacrylic acid.

The binder polymer having a polymerizable ethylenically unsaturated group in its molecule may contain a hydroxyl group in its molecule. This binder polymer having a hydroxyl group and a polymerizable ethylenically unsaturated group can be obtained by introducing a polymerizable ethylenically unsaturated group into a resin having a hydroxyl group. The resin having a hydroxyl group includes a polyol compound, an adduct thereof with alkylene oxide, an adduct of an aromatic compound, etc., having an epoxy group as its side chain with an oxide, and the like. As a polyol compound, polyglycerin is preferred since it is excellent in thermal decomposability at a high temperature.

The compound having an ethylenically unsaturated group that can be introduced to the above resin having a hydroxyl group includes a compound having a carboxyl group that undergoes esterification with a hydroxyl group or an isocyanate group that undergoes an addition reaction with a hydroxyl group. The compound having a carboxyl group includes a compound having a free carboxyl group, and in addition thereto, it may be a compound having a carboxylic ester group. A typical example of the former is (meth)acrylic acid, and typical examples of the latter include methyl (meth)acrylate, 2-hydroxyethyl (meth)acrylate, etc. The compound having an isocyanate group includes an isocyanate group-containing (meth)acrylate obtained from hydroxy (meth)acrylate obtained from (meth)acrylic acid and an alkylene polyhydric alcohol, and a diisocyanate compound (e.g., isophorone diisocyanate).

The hydroxyl value of the above binder polymer having a hydroxyl group and a polymerizable ethylenically unsaturated group is preferably 50 to 800 KOHmg/g from the viewpoint of solubility and durability against an alkali aqueous solution. Further, it is effective to control the acid value simultaneously with the hydroxyl value, and hydroxyl groups can be partially esterified by adding an acid anhydride such as acetic anhydride, etc.

The acid value of the binder polymer (A) having a carboxyl group is preferably 30 to 500 mgKOH/g, more preferably 100 to 300 mgKOH/g. When an alkali aqueous solution is used as the resin layer-removing liquid to be described later, and when the above acid value is less than 30 mgKOH/g, it tends to take a longer time before dissolution. On the other hand, when it exceeds 500 mgKOH/g, the durability of a photo-crosslinked portion against the alkali aqueous solution tends to decrease.

Examples of the binder polymer (A) containing a carboxyl group, which is a combination of two or more polymers, include a combination of two or more polymers having different comonomers, a combination of two or more polymers having different mass average molecular weights, a combination of two or more polymers having different degrees of dispersion (mass average molecular weight/number average molecular weight).

The mass average molecular weight of the binder polymer (A) containing a carboxyl group is preferably 10,000 to 150,000, more preferably 10,000 to 100,000. When this mass average molecular weight is less than 10,000, the durability against an alkali aqueous solution tends to decrease. When it exceeds 150,000, it tends to take a longer time before dissolution.

The photopolymerizable compound (B) having at least one polymerizable ethylenically unsaturated group in its molecule may be any compound that is photo-crosslinkable together with the above binder polymer containing a carboxyl group. Examples thereof include a compound obtained by reacting a polyhydric alcohol with α,β-unsaturated carboxylic acid; a bisphenol A (meth)acrylate compound; a compound obtained by reacting a compound containing a glycidyl group with α,β-unsaturated carboxylic acid; a urethane monomer such as a (meth)acrylate having a urethane bond in its molecule; nonylphenoxypolyethylene oxyacrylate; phthalic acid compounds such as γ-chloro-β-hydroxypropyl-β′-(meth)acryloyloxyethyl-o-phthalate, β-hydroxyalkyl-β′-(meth)acryloyloxyalkyl-o-phthalate, etc.; (meth)acrylic acid alkyl ester, EO- or PO-modified nonylphenyl (meth)acrylate, etc. The above EO and PO represent ethylene oxide and propylene oxide, an EO-modified compound represents a compound having a block structure of ethylene oxide groups and a PO-modified compound represents a block structure of propylene oxide groups. These photopolymerizable compounds may be used singly or in combination.

Further, when a photopolymerizable compound having 3 or more polymerizable ethylenically unsaturated groups in its molecule is used as the photopolymerizable compound (B) having at least one polymerizable ethylenically unsaturated group in its molecule to increase crosslinked points in number, crosslinking can be performed further highly efficiently. The photopolymerizable compound having 3 or more polymerizable ethylenically unsaturated groups in its molecule can be, for example, a compound containing at least one of trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate and trimethylolpropane triglycidyl ether tri(meth)acrylate. When a compound containing no polyalkylene oxide group in its structure is used as a photopolymerizable compound having 3 or more polymerizable ethylenically unsaturated groups in its molecule, a cleaning liquid for a screen printing mask used in screen printing can be inhibited from infiltrating into the resin layer.

When a photopolymerizable compound having 3 or more polymerizable ethylenically unsaturated groups in its molecule is used as the photopolymerizable compound (B) having at least one polymerizable ethylenically unsaturated group in its molecule, preferably, the photopolymerizable compound having 3 or more polymerizable ethylenically unsaturated groups in its molecule is incorporated in an amount of at least 60% by mass based on the total amount of the photopolymerizable compound (B) having at least one polymerizable ethylenically unsaturated group in its molecule, and is incorporated in an amount of 20 to 60% by mass based on the total amount of the carboxyl group-containing binder polymer (A) and the photopolymerizable compound (B) having at least one polymerizable ethylenically unsaturated group in its molecule. When the above amount is less than 60% by mass based on the total amount of the photopolymerizable compound (B), it tends to be difficult to form a crosslinking density sufficiently durable against cleaning that is repeatedly carried out. Further, when the above amount is less than 20% by mass based on the total amount of the binder polymer (A) and the photopolymerizable compound (B), photosensitivity tends to be insufficient. When it exceeds 60% by mass, not only the tacking nature on the resin layer surface becomes conspicuous but also the resin layer cured tends to be fragile.

The photopolymerization initiator (C) includes aromatic ketones such as benzophenone, N,N′-tetramethyl-4,4′-diaminobenzophenone (Michler's ketone), N,N′-tetraethyl-4,4′-diaminobenzophenone, 4-methoxy-4′-dimethylaminobenzophenone, 2,-benzyl-2-dimethylamino-1-(4-morpholinophenyl)-butanone-1,2-methyl-1-[4-(methylthio)phenyl]-2-morpholino-propane, etc.; quinones such as 2-ethylanthraquinone, phenanthrenequinone, 2-tert-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone, 2,3-dimethylanthraquinone, etc.; benzoin ether compounds such as benzoin methyl ether, benzoin ethyl ether, benzoin phenyl ether, etc.; benzoin compounds such as benzoin, methyl benzoin, ethyl benzoin, etc.; benzyl derivatives such as benzyl dimethyl ketal, etc.; 2,4,5-triarylimidazole dimers such as 2-(o-chlorophenyl)-4,5-diphenylimidazole dimer, 2-(o-chlorophenyl)-4,5-di(methoxyphenyl)imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, etc.; acridine derivatives such as 9-phenylacridine, 1,7-bis(9,9′-acridinyl)heptane, etc., N-phenylglycine, N-phenylglycine derivatives, a coumarin compound, etc. Substituents on aryl groups of the two 2,4,5-triarylimidazoles in the above 2,4,5-triarylimidazole dimer may be the same and give a symmetric compound, or they may be different and give an asymmetric compound. Further, a thioxanthone compound and a tertiary amine compound may be combined like a combination of diethylthioxanthone with dimethyl aminobenzoate. These are used singly or in combination.

The resin layer may contain components other than the above (A) to (C) as required. Such components include a thermal polymerization inhibitor, a plasticizer, a colorant (dye and pigment), a photo color developer, a thermal color development inhibitor, a filler, an antifoamer, a flame retardant, a stabilizer, an adherence-imparting agent, a leveling agent, a peel promoter, an antioxidant, a perfume, an imaging agent, a thermal curing agent, a surface tension adjusting agent, a water repellent, an oil repellent, etc., and the resin layer can contain 0.01 to 20% by mass of each of them. These components may be used singly or in combination.

The resin layer may contain a solvent or a mixture of solvents including alcohols such as methanol, ethanol, n-propanol, 2-butanol, n-hexanol, etc.; ketones such as acetone, 2-butanone, etc.; esters such as ethyl acetate, butyl acetate, n-amyl acetate, methyl acetate, ethyl propionate, dimethyl phthalate, ethyl benzoate, etc.; aromatic hydrocarbons such as toluene, xylene, benzene, ethylbenzene, etc.; ethers such as tetrahydrofuran, diethyl ether, ethylene glycol monomethyl ether, ethylene glycol monoethyl ether, 1-methoxy-2-propanol, etc.; N,N-dimethylformamide, dimethyl sulfoxide, and the like.

The amount of the carboxyl group-containing binder polymer (A) based on the total amount of the above binder polymer (A) and the photopolymerizable compound (B) is preferably 40 to 80% by mass, more preferably 45 to 70% by mass. When this amount is less than 40% by mass, a photo-crosslinked portion tends to be decreased in chemical strength and mechanical strength. Further, there is also a problem that film formability is degraded. When it exceeds 80% by mass, photopolymerizability can be decreased.

The amount of the photopolymerizable compound (B) having at least one polymerizable ethylenically unsaturated group in its molecule, based on the total amount of the above binder polymer (A) and the photopolymerizable compound (B), is preferably 20 to 60% by mass, more preferably 30 to 55% by mass. When this amount is less than 20% by mass, photosensitivity tends to be insufficient. When it exceeds 60% by mass, not only tacking nature on a film surface becomes conspicuous, but also a resin layer cured tends to be fragile.

Further, the amount of the photopolymerization initiator (C) based on the total amount of the above binder polymer (A) and the photopolymerizable compound (B) is preferably 0.1 to 20% by mass, more preferably 0.2 to 10% by mass. When this amount is less than 0.1% by mass, photopolymerizability tends to be insufficient. When it exceeds 20% by mass, absorption on a photopolymerizable composition increases during exposure and photo-crosslinking inside the resin layer tends to be insufficient.

When the photopolymerizable resin contains the carboxyl group-containing binder polymer (A), the photopolymerizable compound (B) containing at least one polymerizable ethylenically unsaturated group in its molecule and the photopolymerization initiator (C), the total content of the above binder polymer (A), the photopolymerizable compound (B) and the photopolymerization initiator (C) in the photopolymerizable resin is preferably 80 to 100% by mass, more preferably 90 to 100% by mass, still more preferably 95 to 100% by mass.

The laminated film formed of a photo-crosslinkable resin to be used to coat the above resin layer includes photo-crosslinkable resin films such as a commercially available dry film for forming a circuit, a dry film for forming a solder resist, a photosensitive polyimide film, a capillary film for screen printing, etc.

When the resin constituting the resin layer contains a photo-crosslinkable resin, the resin layer is partially removed by self-alignment to be described later to form openings in/through the resin layer and then the resin layer is imparted with mechanical strength by carrying out treatment for imparting durability by application of ultraviolet ray, whereby the durability against a paste material and a cleaning liquid for a screen printing mask can be further improved, and even when screen printing is repeatedly practiced on a plurality of substrates, excellent printing results can be maintained.

The application of ultraviolet ray is carried out by applying active light with a light source such as a high pressure mercury lamp, an ultra-high pressure mercury lamp, etc. The application dose is preferably 0.5 to 20 J/cm², more preferably 1 to 10 J/cm². When the application dose is less than 0.5 J/cm², unreacted unsaturated groups remain in the photopolymerizable compound in the resin layer, and no resin layer having sufficient hardness tends to be obtained. When it exceeds 20 J/cm², a photo-crosslinking reaction in the resin reaches saturation, and no further application dose is required.

Further, the durability can be further improved by carrying out treatment for imparting durability by heat treatment after the application of ultraviolet ray. The heat treatment promotes the volatilization of an unreacted photopolymerizable compound remaining in a very small content in the photo-crosslinkable resin, and on the other hand, a crosslinking reaction proceeds and higher-density three-dimensional crosslinkage can be completed. The heating temperature is preferably 120 to 170° C., more preferably 140 to 160° C. The heating is preferably carried out for 10 to 90 minutes.

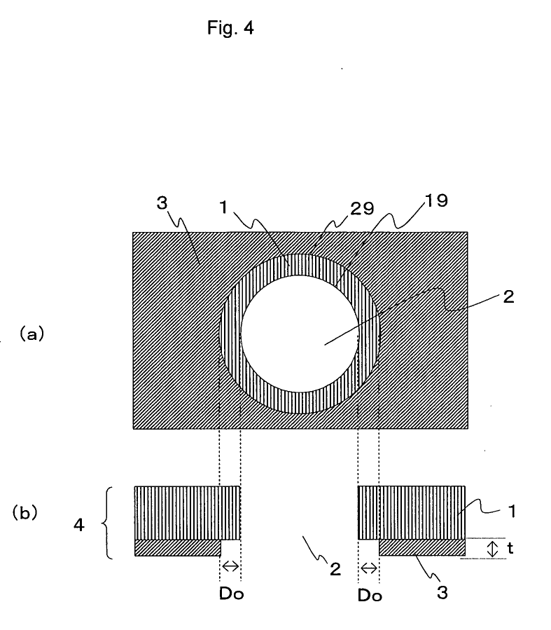

The thickness t of the resin layer (see FIG. 4) is preferably 0.1 to 200 μm, more preferably 1 to 100 μm. The thickness of the resin layer is determined by taking account of the plate thickness of the screen printing mask so that a proper amount of a paste material can be transfer-printed on a substrate to be printed thereon. When the thickness of the resin layer exceeds 200 μm, it is required to decrease the thickness of the screen printing mask to that extent, and dimensional stability and suitability to handling can be sometimes poor. Further, when the thickness of the resin layer is smaller than 0.1 μm, sometimes there cannot be obtained an effect on improvement in sufficient contact between the screen printing mask and a substrate.

When an alkali aqueous solution is used as a resin layer-removing liquid as will be described later, a resin having high solubility in the alkali aqueous solution is used as the resin layer. When an alkali aqueous solution is used as a resin layer-removing liquid, a resin having an acid value of 1 mgKOH/g or more, more preferably 10 mgKOH/g or more, can be suitably used as the resin layer.

In the method of this invention, the resin layer may be formed after the screen printing mask is made. There can be therefore employed a constitution in which additional processing is practiced after openings are made in/through the screen printing mask, and thereafter the resin layer is formed. Examples of the additional processing include polishing treatments such as electrolytic polishing, chemical polishing, mechanical polishing, etc., and surface treatments including surface treatments of a screen printing mask including treatments of inner wall surfaces of the openings, such as fluorine resin coating, silicon resin coating, etc.

The contact surface to a substrate is subjected to polishing treatment when a screen printing mask is made. When desired flatness and smoothness of contact surface of the substrate can be obtained by the formation of the resin layer, the treatment to polish the contact surface of a screen printing mask to a substrate can be omitted.

In the method of this invention, the partial removal of the resin layer by self-alignment means that those parts of the resin layer which are to be removed are registered by the use of openings made in/through a screen printing mask and the resin layer is partially removed.

In the method of this invention, preferably, the step of partially removing the resin layer by self-alignment is practiced by supplying a resin layer-removing liquid from the other main surface that the screen printing mask has opposite to the main surface on which the resin layer is formed. When wet treatment by a resin layer-removing liquid is employed, the resin layer can be removed excellently, uniformly and highly productively regardless of the thickness and dimensions of the screen printing mask.

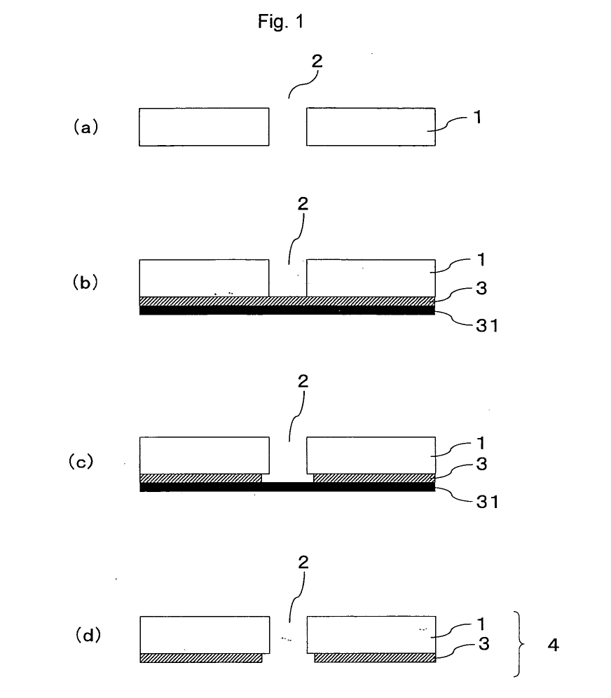

An example of making a resin-formed screen printing mask by the above method will be explained with reference to FIG. 1. A resin layer 3 and a masking layer 31 are formed on one main surface of a screen printing mask 1 (FIG. 1(a)) having an opening by laminating (FIG. 1(b)). Then, a resin layer-removing liquid is supplied from the main surface opposite to the surface on which the above resin layer is formed, to remove resin layer 3 in the opening 2 of a first surface (FIG. 1(c)). In this case, since the masking layer 31 is present on the surface that the resin layer 3 has opposite to the screen printing mask 1, resin layer 3 other than that in the opening 2 is cannot be removed. Then, the masking layer 31 is removed to obtain a resin-formed screen printing mask 4 (FIG. 1(d)). The masking layer 31 can be formed after the lamination of the resin layer 3. From the viewpoint of productivity, however, there is preferred a method in which the masking layer 31 is formed integrally with the resin layer 3 beforehand and then press-bonded to the screen printing mask 1 together with the resin layer 3.

The above resin layer-removing liquid is selected from liquids that can dissolve or disperse the resin layer and that are suitable for the composition of the resin layer to be used. Openings are formed in/through the resin layer by means of the resin layer-removing liquid. As a resin layer-removing liquid, there is used a liquid that does not dissolve the masking layer or that dissolves the masking layer but does not cause the swelling or deformation of the masking layer under conditions where only a proper amount of the resin layer is dissolved. Further, the resin layer-removing liquid that is used does not dissolve, swell or deform the screen printing mask. The resin layer-removing liquid can be selected, for example, from aqueous solutions of inorganic basic compounds such as alkali metal silicate, alkali metal hydroxide, alkali metal phosphate, alkali metal carbonate, ammonium phosphate or carbonate, and besides these, it can be also selected from organic basic compounds such as ethanolamine, ethylenediamine, propanediamine, triethyltetramine, morpholine, etc. As a resin layer-removing liquid, it is particularly preferred to use an aqueous solution containing at least one selected from alkali metal carbonate, alkali metal phosphate, alkali metal hydroxide and alkali metal silicate.

The method for supplying the resin layer-removing liquid includes methods using a dipping apparatus, a double-side shower spraying apparatus, a one-side shower spraying apparatus, etc. In the removal of the resin layer, it is required to adjust the concentration and temperature of the resin layer-removing liquid, the spraying pressure for supplying the resin layer-removing liquid, etc., in order to control the power of dissolving the resin layer. It is sufficient to employ a constitution in which the resin layer-removing liquid is supplied through openings of the screen printing mask from the other main surface that the screen printing mask has opposite to the main surface on which the resin layer is formed, so that the resin layer-removing liquid comes in contact with the resin layer. The removal of the resin layer can be readily terminated by ensuring that the treatment with the resin layer-removing liquid is followed by washing with water or treatment with an acid.

The treatment conditions (temperature, spraying pressure and time period) for removing the resin layer are adjusted as required depending upon the degree of dissolving of the resin layer. Specifically, the treatment temperature is preferably 10 to 50° C., more preferably 15 to 40° C., still more preferably 15 to 35° C. When a double-side shower spraying apparatus or a one-side shower spraying apparatus is used, the spraying pressure is preferably 0.05 to 0.5 MPa, more preferably 0.1 to 0.3 MPa.

For the masking layer, there can be used a resin, a metal, etc., which are insoluble or sparingly soluble in the resin layer-removing liquid. The resin for constituting the masking layer can be selected from an acrylic resin, a vinyl acetate resin, a vinyl chloride resin, a vinylidene chloride resin, a vinyl acetyl resin such as polyvinyl butyral, polystyrene, polyethylene, polypropylene and chlorides thereof, a polyester resin such as polyethylene terephthalate, polyethylene isophthalate, a polyamide resin, a vinyl-modified alkyd resin, a phenolic resin, a xylene resin, a polyimide resin, gelatin and a cellulose ester derivative such as carboxymethyl cellulose. In view of general availability, a polyester resin, a polyimide resin, etc., can be suitably used. As a metal for constituting the masking layer, copper, aluminum, etc., can be used. As a masking layer, it is more preferred to use a resin than to use a metal from the viewpoint of simplicity and in-plane uniformity. Preferably, the masking layer is formed in the form of a film on a substrate integrally with the resin layer, since the resin layer and the masking layer can be formed simply and stably in view of the step of forming it. When an alkali aqueous solution is used as a resin layer-removing liquid, a resin having an acid value that is one tenth or less, preferably one hundredth or less of the acid value of the resin layer can be suitably used for forming the masking layer.

As a method for integrally forming the resin layer and the masking layer in this invention, there can be suitably used a method in which the resin layer is formed on a film-shaped support that is to constitute the masking layer and the resultant set is laminated on a screen printing mask having openings with a laminator.

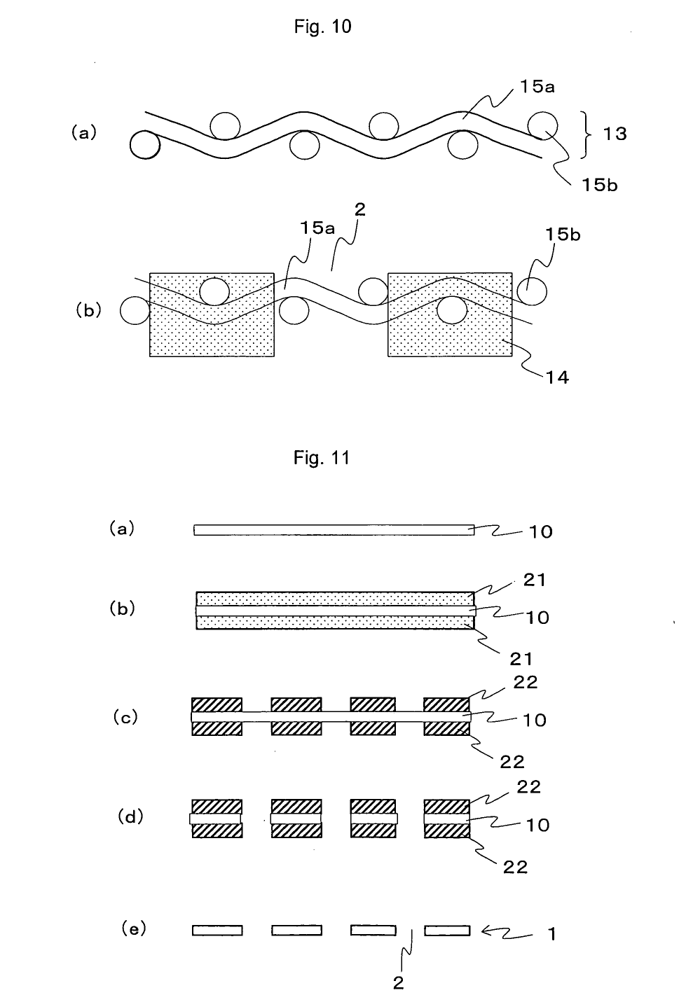

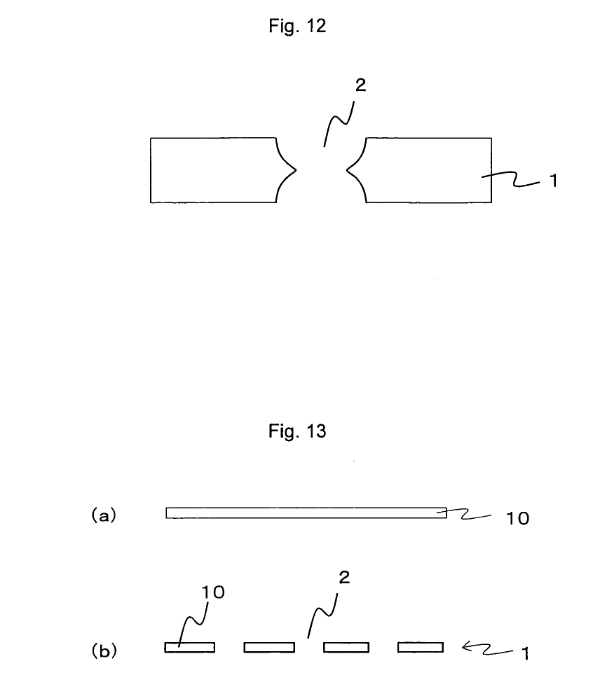

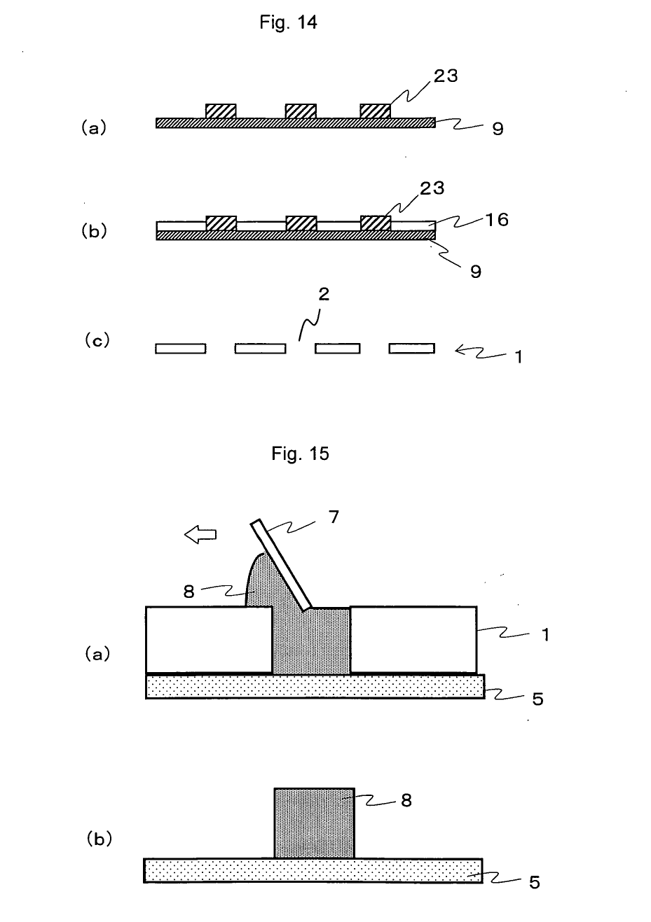

While FIG. 1 explains an example using a screen printing mask having no mesh layer, such as a metal mask, etc., the resin layer can be similarly formed on a screen printing mask having a mesh layer as shown in FIG. 10 and can be partially removed.

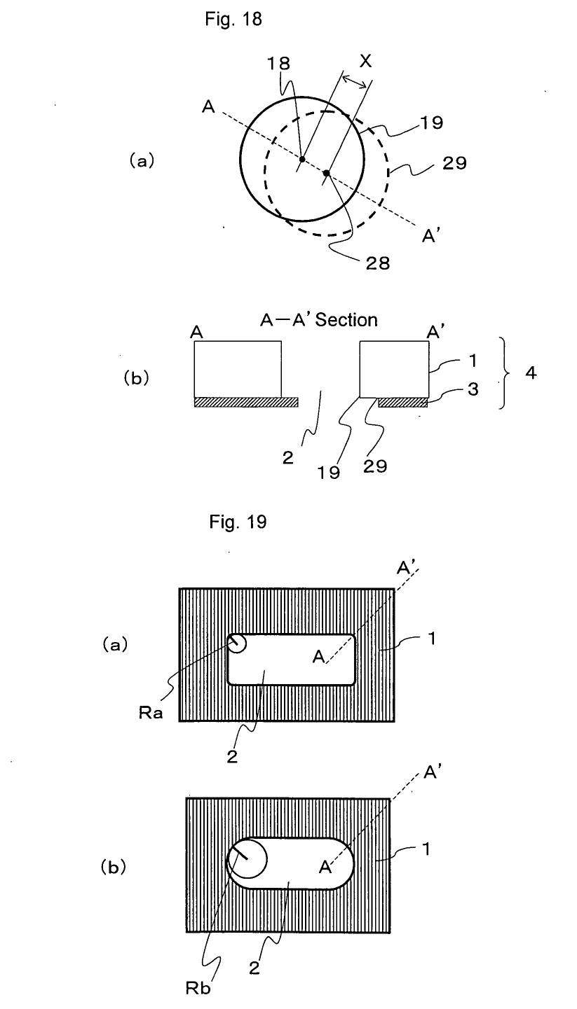

In openings that are formed in/through the resin layer by partially removing the resin layer by self-alignment, the deviation of centroid thereof in position relative to the openings of the screen printing mask can be decreased. The deviation of centroids in position (distance X in FIG. 18(a)) can be adjusted to 5 μm or less, preferably to 3 μm or less. On the basis of the above self-alignment, further, the form of those portions of the resin layer which are to be removed can be defined by utilizing the form of openings made in/through a printing mask.

Preferably, the method of this invention comprises the step of forming an electrodeposition resin layer on the resin layer after the step of coating one main surface of said screen printing mask with the resin layer but before the step of forming the openings through the resin layer, said electrodeposition resin layer being coated on the resin layer excluding those parts of said resin layer which are positioned nearly in the same locations as those of openings of said screen printing mask, the step of removing parts of said resin layer by self-alignment being practiced by supplying a resin layer-removing liquid from the one main surface of said screen printing mask on which the resin layer and the electrodeposition layer are formed.

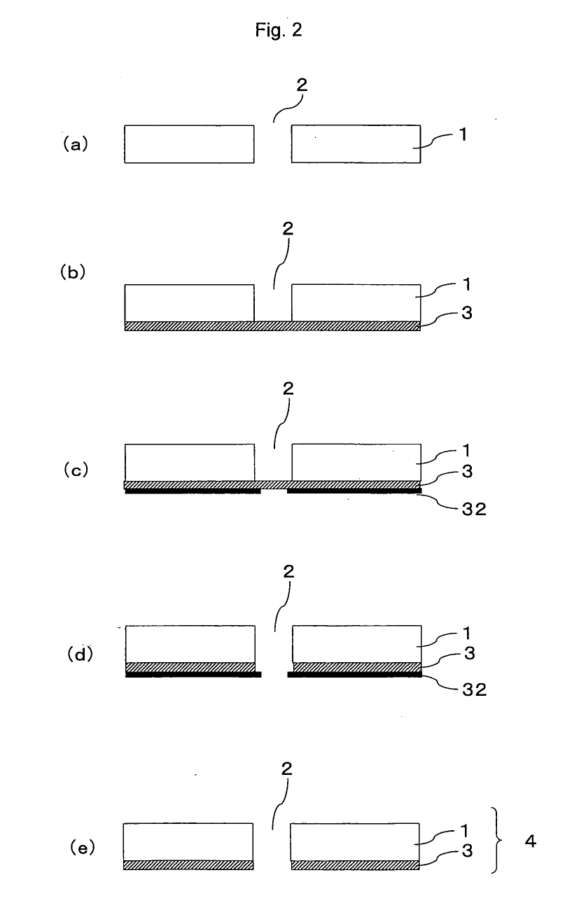

An example of making the resin-formed screen printing mask by the above method will be explained with reference to FIG. 2. A resin layer 3 (FIG. 2(b)) is formed on one main surface of a screen printing mask 1 (FIG. 2(a)) having an opening 2 by laminating, and an electrodeposition resin layer 32 (FIG. 2(c)) is formed on the resin layer 3 excluding that part of the resin layer which is positioned nearly in the same location as that of the opening 2 of said screen printing mask. Then, the resin layer-removing liquid is supplied from the main surface on which the resin layer and the electrodeposition resin layer are formed, to remove resin layer 3 (FIG. 2(d)) that faces the opening 2. Then, the electrodeposition resin layer 32 is peeled off as required, whereby a resin-formed screen printing mask 4 is made (FIG. 2(e)).

For the above electrodeposition resin layer, any resin can be used so long as it is in soluble or sparingly soluble in the resin layer-removing liquid and can be used in an electrodeposition method. Examples thereof include an acrylic resin, a vinyl acetate resin, a vinyl chloride resin, a vinylidene chloride resin, a vinyl acetal resin like polyvinyl butyral, polystyrene, polyethylene, polypropylene and chlorides thereof, polyester resins such as polyethylene terephthalate, polyethylene isophthalate, etc., a polyamide resin, a vinyl-modified alkyd resin, gelatin and cellulose ester derivatives including carboxymethyl cellulose.

When the electrodeposition resin layer is formed, a dispersion prepared by dispersing a resin for the electrodeposition resin layer, in the state of particles, is used. The particles are positively or negatively charged. As a dispersing medium, water or an electrically insulating liquid can be used. The electrically insulating liquid includes a linear or branched aliphatic hydrocarbon, an alicyclic hydrocarbon, an aromatic hydrocarbon and halogen-substituted products of these. Examples thereof include octane, isooctane, decane, isodecane, decalin, nonane, dodecane, isodecane, cyclohexane, cyclooctane, cyclodecane, benzene, toluene, xylene, mesitylene, etc. Commercial product names therefor are Isopar E, Isopar G, Isopar H, Isopar L (manufactured by Exxon Mobil Corporation), IP solvent 1620 (manufactured by Idemitsu Kosan Co., Ltd.), etc. These highly insulating media can be used singly or as a mixture. When water is used as a dispersing medium, the electrodeposition resin layer is composed of a polymer having a proper acid value and is neutralized with an organic amine, etc., to form charged colloid particles in water. When an electrically insulating liquid is used, various resins in the state of particles are dispersed in the electrically insulating liquid. The particles can contain a charge control agent, and as the charge thereof, positive or negative charge is selectively used depending upon the positive or negative state of a bias voltage when the electrodeposition resin layer is formed. As a liquid of a resin for forming the electrodeposition resin layer in the above electrically insulating liquid, a liquid toner for electrophotography can be suitably used.

The electrodeposition resin layer is formed, for example, in the following manner. A developing electrode is placed so as to face a main surface of resin layer-coated screen printing mask, a liquid in which charged resin particles are dispersed is filled between the resin layer of main surface of the screen printing mask and the developing electrode, and a proper electric field is applied between the developing electrode and the screen printing mask, whereby the resin particles are electrically deposited to form electrodeposition resin layer. The thickness of the electrodeposition resin layer can be determined by controlling electrodeposition conditions (charge and application voltage of/to resin particles, treatment time period, amount of resin particle dispersion to be supplied, etc.). The resin particles that have adhered by the electrodeposition method are fixed onto the resin layer by heating, pressure, light, solvent, etc., to form the electrodeposition layer.

For forming the electrodeposition resin layer, it is required to use a screen printing mask having the main surface that at least has electric conductivity, the main surface being the surface on which the resin layer is to be formed. When this constitution is employed, the resin particles have a larger electric field exerted thereon toward a surface having no openings (surface on non-openings), and the amount of the resin particles adhering to the resin layer surface on non-openings becomes larger than the amount of the resin particles adhering to the resin layer surface on the openings. The adherence amount of the resin particles can be controlled by properly adjusting the electrodeposition conditions. The electrodeposition conditions are set so as to ensure that the resin layer surface on the openings has an adherence amount of the resin particles which is insufficient for completely coating the resin layer and that the resin layer surface on the non-openings has an adherence amount of the resin particles which is sufficient for completely coating the resin layer. As a result, only the resin layer on the openings, which is not coated with the electrodeposition resin layer, can be removed by supplying the resin layer-removing liquid. The width of each opening of the resin layer can be controlled by controlling the conditions for removal with the resin layer-removing liquid together with the electrodeposition conditions. The electrodeposition resin layer is removed as required after the resin layer on the openings is removed, whereby a resin-formed screen printing mask is made.

As the resin layer and the resin layer-removing liquid, those which have no detrimental effects on the formation of the electrodeposition resin layer and the removal of the resin layer can be selected from the above-explained resin layers and the resin layer-removing liquids. As a method for supplying the resin layer-removing liquid and a specific example of removal conditions, those similar to the above-explained embodiments can be employed. In this method, the opening state of the resin layer (range of resin layer to be removed) can be excellently controlled by properly controlling the adherence state of the electrodeposition resin layer. Therefore, a desired opening area of the resin layer and a desired opening form of the resin layer can be obtained, and there can be obtained a resin-formed screen printing mask that can accomplish an excellent printing quality.

Further, FIG. 2 explains the example regarding the screen printing mask having no mesh layer such as a metal mask, etc., while the resin layer can be formed on a screen printing mask having a mesh layer as shown in FIG. 10 and can be partially removed.

In the method of this invention, preferably, the step of partially removing the resin layer by self-alignment is carried out by supplying the resin layer-removing liquid after those parts of the above resin layer which are positioned nearly in the same locations as those of openings of the above screen printing mask are decreased in thickness.

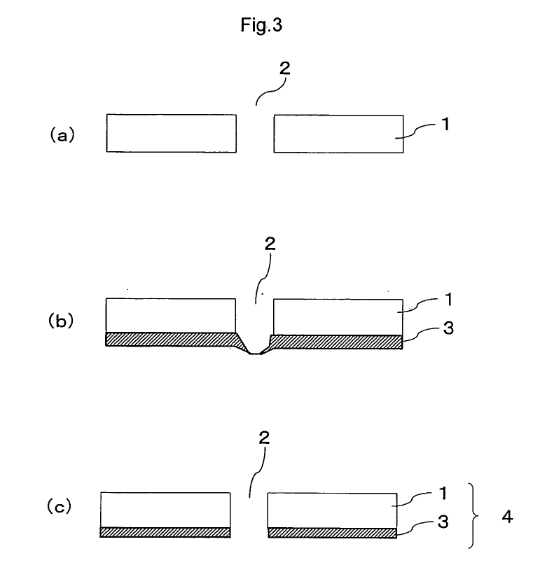

An example of making a resin-formed screen printing mask by the above method will be explained with reference to FIG. 3. A resin layer 3 is coated on one main surface of a screen printing mask 1 (FIG. 3(a)) having an opening 2 by laminating, and then, that part of the resin layer 3 which is positioned nearly in the same location as that of opening of the screen printing mask 1 is decreased in thickness (FIG. 3(b)). Then, that part of the resin layer 3 which is decreased in thickness is removed by supplying the resin layer-removing liquid, to make a resin-formed screen printing mask 4 (FIG. 3(c)). The decreasing of the resin layer 3 in thickness can be carried out by heat treatment, pressure treatment, decompression treatment, or the like. When heat treatment is practiced, it is generally carried out at 40° C. or higher but 150° C. or lower, more preferably at 60° C. or higher but 120° C. or lower although it differs depending upon the kind of the resin layer. Further, when the thickness is decreased by heat treatment, there can be employed a constitution in which a resin layer is coated on the main surface that the screen printing mask has opposite to the main surface on which the resin layer has been formed beforehand, to make air inside the opening 2 of the mask airtight and the thermal expansion of the air is utilized to decrease the thickness of that part of the resin layer 3 which is in contact with the opening 2 of the mask. The treatment with the resin layer-removing liquid is carried out after the thickness of the resin layer 3 on the opening 2 is decreased, whereby the resin layer 3 on the opening 2 can be removed. In this case, the resin layer-removing liquid can be supplied from any one of the main surfaces of the screen printing mask.

When the resin layer is partially removed by the above method, a resin layer and a resin layer-removing liquid that have no detrimental effects on the decreasing of the resin layer in thickness and the removal of the resin layer can be as well selected from those which are explained hereinabove. As a method for supplying the resin layer-removing liquid and a specific embodiment of removal conditions, a method and a specific example similar to those explained hereinabove can be employed as well.

Further, FIG. 3 explains the example regarding the screen printing mask having no mesh layer such as a metal mask, etc., while the resin layer can be formed on a screen printing mask having a mesh layer as shown in FIG. 10 and can be partially removed.

In the resin-formed screen printing mask obtained by the method of this invention, preferably, the area of the openings made in/through the resin layer is larger than the area of the openings of the screen printing mask.

FIG. 4(a) is a plan view of one example of the resin-formed screen printing mask obtained by the method of this invention, viewed from the resin layer side, and FIG. 4(b) is a cross-sectional view thereof. In an opening 2 of a screen printing mask 1, a distance Do (which will be referred to as “offset width”) from an edge portion 29 of a resin layer 3 to an edge portion 19 of a screen printing mask 1 is adjusted to Do>0. In this case, not only the application pressure (filling pressure) of a paste material is decreased, but also the contact area of a substrate to the paste material is increased, so that improvements can be made in overcoming of the bleeding and passing failure of the paste material.

The above offset width Do is preferably 0.1 to 200 μm, more preferably 0.5 to 100 μm. However, the optimum value of the offset width Do differs depending upon the kind of the substrate on which printing is to be practiced, the kinds of the screen printing mask and the resin layer, the pattern forms of the screen printing mask and the resin layer, the kind of the paste material, the transfer amount of the paste material, the screen printing conditions, and the like. When the offset width Do is smaller than 0.1 μm, there can be no longer fully exhibited the application pressure decreasing effect or the effect on improvement in overcoming of the passing failure of the paste material by an increase in the contact area of the substrate to the paste material. When the offset width is larger than 200 μm, it is difficult to form a high-precision pattern intended for high-density mounting.

As a method for controlling the offset width Do, there can be employed a method in which two resin layer-removing liquids (resin layer-removing liquid (a) and resin layer-removing liquid (b)) are used and two-stage treatments are carried out to remove the resin layer. First, when the treatment is carried out with a resin layer-removing liquid (a), resin layer components form micelle and then become insoluble, so that the resin layer components are prevented from being dissolved and dispersed in the resin layer-removing liquid (a). Thereafter, a resin layer-removing liquid (b) is supplied, when the insolubilized micelle is dissolved and re-dispersed, whereby resin layer is removed. Then the removal of resin layer is carried out in the above manner, the offset width Do can be stably controlled so as to have a desired value.

As a resin layer-removing liquid (a), there can be suitably used an aqueous solution containing at least one inorganic alkaline compound selected from alkali metal carbonate, alkali metal phosphate, alkali metal hydroxide and an alkali metal silicate and having its content of 5 to 20% by mass. The content of the inorganic alkaline compound in the resin layer-removing liquid (a) is preferably 7 to 20% by mass, more preferably 10 to 20% by mass. When the content of the inorganic alkaline compound is less than 5% by mass, the micelle is not easily insolubilized, and the micelle is sometimes liable to be dissolved and dispersed in the resin layer-removing liquid (a). Further, when it exceeds 20% by mass, precipitation is liable to take place, and the resin layer-removing liquid is poor in stability with time and workability. The resin layer-removing liquid (a) preferably has a pH in the range of 9 to 13. Further, a surfactant, an antifoamer, etc., may be added as required.

As a resin layer-removing liquid (b), any liquid can be used so long as it is a liquid that can dissolve and redisperse the insolubilized micelle generated by the treatment with the resin layer-removing liquid (a) and that, after the micelle is dissolved and dispersed, does not perform or hardly performs the removal of the insulating resin layer any further by the treatment with the resin layer-removing liquid (b) alone. As a resin layer-removing liquid (b), water per se or an acidic or alkaline aqueous solution having a pH of 6 to 10 is suitable. Specifically, water per se or an aqueous solution containing at least one inorganic alkaline compound selected from alkali metal carbonate, alkali metal phosphate, alkali metal hydroxide and alkali metal silicate and having its content of 3% by mass or less is preferred, and water per se or an aqueous solution containing at least one inorganic alkaline compound selected from alkali metal carbonate and alkali metal phosphate and having its content of 3% by mass or less is more preferred. When the treatment is carried out with water per se or an aqueous solution containing at least one inorganic alkaline compound selected from alkali metal carbonate, alkali metal phosphate, alkali metal hydroxide and alkali metal silicate and having its content of 3% by mass or less, the micelle insolubilized by the resin layer-removing liquid (a) is improved in redispersibility, which enables the rapid treatment. The resin layer-removing liquid (b) may also contain a surfactant, an antifoamer, etc., as required.

When the opening form of the resin layer is circular, desirably, the offset width D has a constant value along the contour of the opening 2.

In the method of this invention, when the openings of the screen printing mask and the openings of the resin layer in the resin-formed screen printing mask obtained have nearly similar forms, when the area of each opening of the resin layer is larger than the area of each opening of the screen printing mask, and when a distance from the edge portion of opening of the screen printing mask to the edge portion of a resin layer in the vicinity of said opening of the screen printing mask is taken as an offset width, preferably, the offset width of a portion having a small curvature radius in the contour of opening of the screen printing mask is smaller than the offset width of a portion having a larger curvature radius in the contour of opening of the screen printing mask.

In this case, the resin layer is formed such that the offset width in a portion having a small curvature radius in the contour of an opening is smaller than the offset width in a portion having a large curvature radius in the contour of each opening in the non-circular opening of the resin layer.

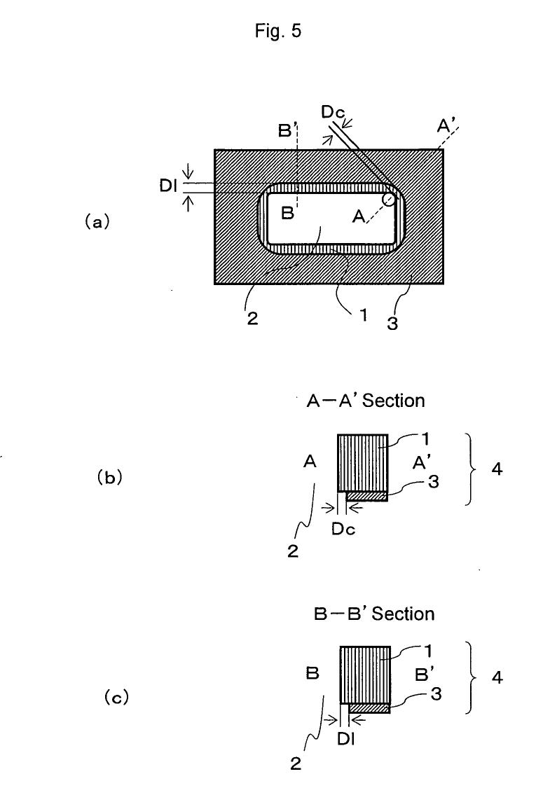

The resin-formed screen printing mask obtained by the method of this invention will be explained below regarding a rectangular opening as an example with reference to FIGS. 5, 7, 19 and 20.

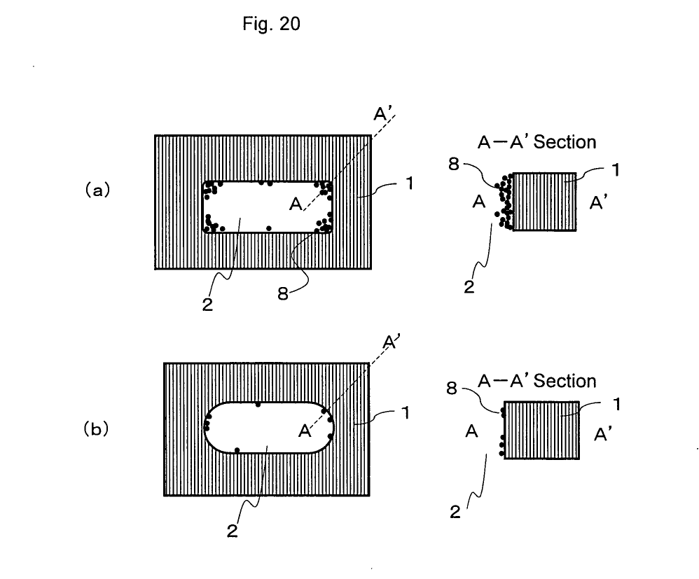

For example, when an opening 2 of a screen printing mask has corner portions of a small curvature radius Ra as shown in FIG. 19(a), the lodging of a paste material 8 sometimes takes place in the screen printing mask 1 as shown in FIG. 20(a) after the paste material 8 is screen-printed. In contrast, in a screen printing mask having an opening 2 having corner portions of a large curvature radius Rb, an improvement is made to decrease the lodging of a paste material 8 as shown in FIG. 20(b) and the transfer amount thereof is stabilized.

As shown in FIG. 5(a), when the offset width of a portion (corner portion) of a small curvature radius in the opening 2 of the screen printing mask 1 is taken as Dc, and when the offset width of a portion (straight line portion) of a large curvature is taken as D1, preferably, the opening of the resin layer 3 of the resin-formed screen printing mask obtained by the method of this invention is formed to ensure D1>Dc. When the opening of the resin layer 3 is formed as described above, the opening of the resin layer 3 that comes in contact with a substrate has a large curvature radius in a small-curvature portion (corner portion) of the opening 2 of the screen printing mask 1. When screen printing is carried out with such a resin-formed screen printing mask 4, an improvement is made to decrease the lodging of a paste material 8 in the corner portions of opening 2 of the screen printing mask as shown in FIGS. 7(a) and 7(b) as compared with the showing of FIG. 20(a). That is, a stable transfer amount can be transfer-printed like a screen printing mask 1 whose opening 2 has corner portions of a large curvature radius Rb as shown in FIG. 19(b).

For attaining D1>Dc as shown in FIG. 5(a), for example, 2 kinds of the resin layer-removing liquids are used and the conditions for treatments with them are changed as required as described above.

In the method of this invention, the curvature radius of opening of the resin layer 3 is controlled, labor and time for making a screen printing mask can be saved and there can be obtained a resin-formed screen printing mask that materializes the capability of excellently passing a paste material.

While FIGS. 5, 7, 19 and 20 explain an example of the opening that is rectangular in form, the opening may have the form of a polygon or other non-circular form. In such a case, if the opening partially has a portion that has a small curvature radius, the resin layer corresponding to that portion is formed so as to have a larger curvature radius, whereby the lodging problem of a paste material in that curvature radius portion can be overcome.

The resin-formed screen printing mask of this invention will be explained below.

The resin-formed screen printing mask of this invention is characterized in that it is made by the method recited in any one of the above mentioned (1) to (8).

The resin-formed screen printing mask of this invention can be applied to any screen printing, while it is generally attached to a rigid frame for use. For example, a mesh (gauze) is bonded to a frame made of a rigid metal first, and that circumferential portion of an obtained resin-formed screen printing mask which is opposite to the resin layer is bonded to the middle portion of the mesh with an adhesive. Then, inside mesh other than the bonding portion is cut off, whereby the resin-formed screen printing mask with the frame can be made.

Alternatively, a resin layer is formed on a screen printing mask attached to a frame beforehand by the method of this invention, and it is partially removed by self-alignment, whereby a resin-formed screen printing mask with the frame can be obtained.

Since the resin-formed screen printing mask of this invention is made by the method of this invention, a resin-formed screen printing mask having a form capable of transfer-printing a proper transfer amount of a paste material without the problems of bleeding, a passing failure and abnormal transfer can be made even based on simple data designing.

This invention will be more specifically explained below with reference to Examples, while this invention shall not be limited by these Examples.

### EXAMPLES

### Example 1

A 0.2 mm thick SUS304 stainless steel plate was employed as a substrate for an additive (electroforming) method, and a 100 μm thick photosensitive plating resist layer was formed on the surface thereof. The substrate was subjected to pattern exposure and developing treatments with a photomask having a plurality of exposure regions having the form of a circle with a diameter of 200 μm each to form columnar plating resist layers having a diameter of 200 μm each on the substrate surface. This substrate having the plating resist layer was immersed in a nickel sulfamate plating bath and electrically plated under conditions of 2 A/dm² and a bath temperature at 45° C. to form an 80 μm thick nickel layer on the substrate other than the columnar plating resist layers. Then, the plating resist layer was removed and the nickel layer was peeled off the substrate to give, as a screen printing mask, a metal mask formed of a nickel layer having circular openings according to the additive method.

A resin film formed of a resin layer (thickness 20 μm) containing components shown in Table 1 and a 25 μm thick masking layer (support film, material: polyester) was thermally press-bonded to one main surface of the metal mask with a laminator to form the resin layer and the masking layer (support film).

TABLE 1

| Component | | Mass % |
|---|---|---|
| Carboxyl group- | Copolymer having a weight | 55.4 |
| containing binder | average molecular weight of | |
| polymer (A) | 25,000, obtained by | |
| | copolymerization of methyl | |
| | methacrylate/n-butyl | |
| | acrylate/methacrylic acid in | |
| | mass ratio of 64/15/21. | |
| Photopolymerizable | Trimethylol propane | 35 |
| compound (B) | triacrylate (trade name: TMP- | |
| containing at least | A, supplied by KYOEISHA | |
| one polymerizable | CHEMICAL CO., LTD.) | |
| ethylenically | | |
| unsaturated group | | |
| in its molecule | | |
| Photopolymerizable | 2,2′-bis-(4-methacryloxypenta- | 5 |
| compound (B) | ethoxyphenyl)propane (trade | |
| containing at least | name: BPE-500, supplied by | |
| one polymerizable | SHIN-NAKAMURA CHEMICAL CO., | |
| ethylenically | LTD.) | |
| unsaturated group | | |
| in its molecule | | |
| Photopolymerization | 2-(2′-chlorophenyl)-4,5- | 4.0 |
| initiator (C) | diphenylimidazole dimer | |
| Photopolymerization | 4,4′-bis(diethylamino)- | 0.5 |
| initiator (C) | benzophenone | |
| Pigment | Phthalocyanine Green | 0.1 |

Then, two liquids (resin layer-removing liquid (a) and resin layer-removing liquid (b)) were employed as resin layer-removing liquids, and the resin layer was removed with them. A 10 mass % sodium carbonate aqueous solution (25° C.) was used as a resin layer-removing liquid (a), and water, as a resin layer-removing liquid (b). Each was applied, with a shower spray, to the side of the main surface that the metal mask had opposite to the side on which the resin layer and the masking layer (support film) had been formed, to remove resin layer on the openings. The time period for treatment with the resin layer-removing liquid (a) was adjusted, and the treatment was carried out to ensure an offset width of 5 μm. Then, the masking layer was removed.

Then, ultraviolet ray was applied to the resin layer for 300 seconds with a baking high-pressure mercury lamp light source (Unilec URM300, supplied by Ushio, Inc., exposure dose: 12 mW/cm²) having a suction adhesion mechanism, followed by heating in an oven at 150° C. for 30 minutes, whereby a durability-imparted resin-formed screen printing mask (thickness 100 μm) was made.

Openings of the thus-obtained resin-formed screen printing mask were observed through a microscope, and as a result it was found that the offset width was uniformly 5 μm. Further, there was found no deviation in the positions of centroids of opening forms of the screen printing mask and the resin layer.

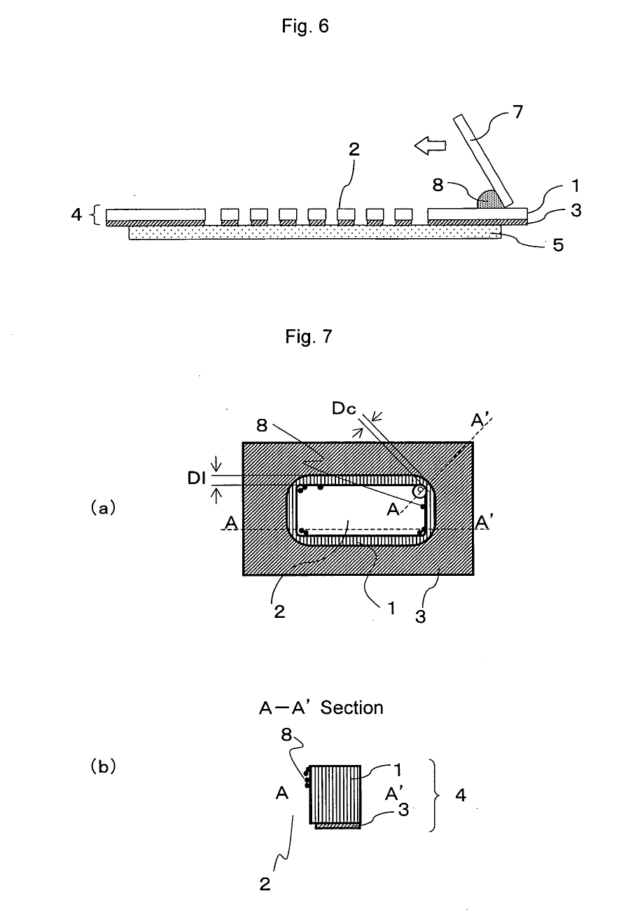

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Example 2

A plurality of rectangular (200 μm×300 μm) openings as shown in FIG. 19(a) were formed in/through an 80 μm thick stainless plate (SUS304) with YAG laser to make, as a screen printing mask, a metal mask according to a laser method. Corner portions of the rectangular openings had a curvature radius Ra of 20 μm each. A resin-formed screen printing mask (thickness 100 μm) was made in the same manner as in Example 1. However, the time period for treatment with the resin layer-removing liquid (a) was adjusted such that the offset width D1 of a straight line portion shown in FIG. 5(a) was 7 Openings of the thus-obtained resin-formed screen printing mask were observed through a microscope, and as a result, there was found no deviation in the positions of centroids of opening forms of the screen printing mask and the resin layer. Further, it was found that the offset width D1 in the straight line portion shown in FIGS. 5(a) and 5(c) was 7 μm and that the offset width Dc in corner portions shown in FIGS. 5(a) and 5(b) was 5 μm.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

When openings of the resin-formed screen printing mask were observed after the screen printing, it was found that a small amount of paste material 8 remained in the openings 2 as shown in FIGS. 7(a) and 7(b), but it was found that the paste material 8 was excellently transfer-printed.

### Comparative Example 1

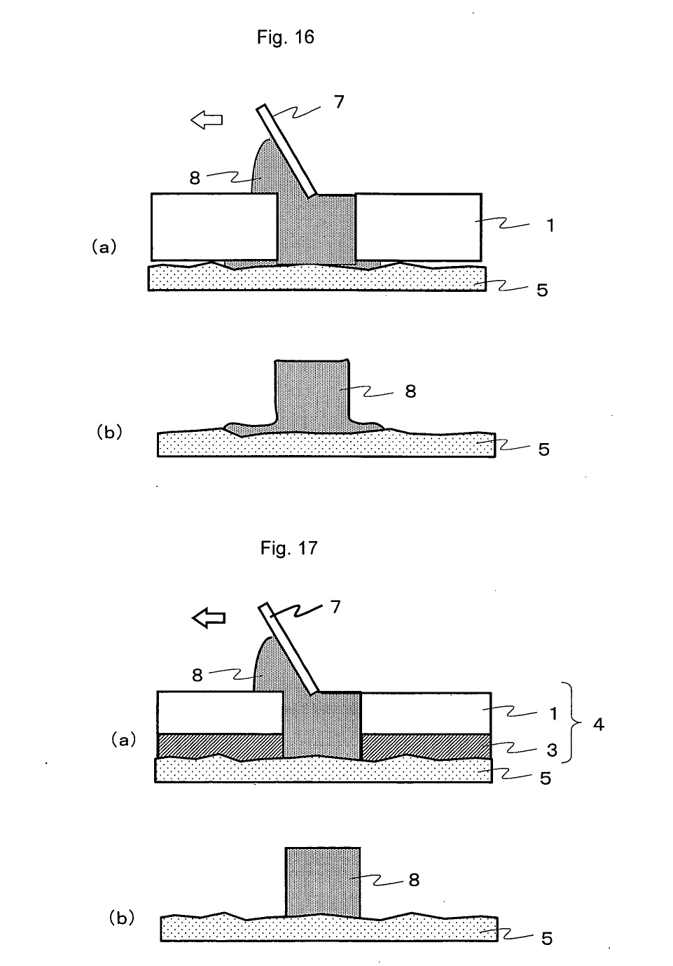

Rectangular openings were made in/through a 100 μm thick stainless plate (SUS304) and used as a screen printing mask (thickness 100 μm) in the same manner as in Example 2 except that no resin layer was formed. When screen printing was carried out with this mask, the bleeding of a paste material 8 as shown in FIG. 16(b) was found in some places. Further, the transfer amount of the paste material was insufficient. Further, as the printing was repeated, an increased transfer amount of the paste material was observed in some places, and the transfer amount was unstable.

When the openings of the screen printing mask were observed after the screen printing, the lodging of a paste material 8 was observed in many corner portions of the openings 2 as shown in FIG. 2, and it was found the lodging of the paste material 8 in the corner portions caused the insufficient transfer amount and the unstable transfer amount.

### Comparative Example 2

A resin layer (thickness 20 μm) formed from components shown in Table 1 was formed on an 80 μm thick stainless steel plate (SUS304). Then, holes were made in/through both the resin layer and the stainless steel plate with YAG laser to form rectangular (200 μm×300 μm) openings, whereby a resin-formed screen printing mask was obtained.

Openings of the thus-completed resin-formed screen printing mask were observed through a microscope, and as a result it was found that the area of the openings of the resin layer was larger than the area of the openings of the stainless steel plate. However, the resin layer was thermally deformed, and the offset width was varied from 0 μm to 50 μm.

When cream solder as a paste material 8 was screen-printed with a squeegee 7 using the above-obtained resin-formed screen printing mask 4 as shown in FIG. 6, there was caused the bleeding of cream solder, which was thought to be caused by the deformation of the resin layer, and a transfer printing in an excellent form could not be performed.

### Example 3

Photosensitive etching resists were formed on both surfaces of an 80 μm thick SUS304 stainless steel plate. Then, a photomask that was negative-positive inversed mask of the photomask used in Example 1 was employed and pattern exposure was applied to a region other than circular portions having a diameter of 200 μm each. Then, developing treatment was carried out to form an etching resist layer having circular openings, and etching treatment was then carried out to form openings having a diameter of 200 μm each in/through the stainless steel plate. Then, the etching resist layer was removed to make, as a screen printing mask, a metal mask according to an etching method. A resin layer was formed on the metal mask in the same way as in Example 1, to make a resin-formed screen printing mask (thickness 100 μm). However, the time period for treatment with the resin layer-removing liquid (a) was adjusted such that the offset width was 10 μm.

Openings of the thus-obtained resin-formed screen printing mask were observed through a microscope, and as a result, there was found no deviation in the positions of centroids of opening forms of the screen printing mask and the resin layer. Further, it was found that the offset width was 10 μm.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Example 4

The used resin-formed screen printing mask, which had been used for the screen printing in Example 2, was treated with a 3 mass % sodium hydroxide aqueous solution to peel off the resin layer. Then, a resin layer was again formed in the same manner as in Example 2, to make a resin-formed screen printing mask (thickness 100 μm) whose resin layer alone was renewed.

Openings of the thus-obtained resin-formed screen printing mask were observed through a microscope, and as a result, there was found no deviation in the positions of centroids of opening forms of the screen printing mask and the resin layer. Further, it was found that the offset width D1 in the straight line portion shown in FIGS. 5(a) and 5(c) was 7 μm and that the offset width Dc in corner portions shown in FIGS. 5(a) and 5(b) was 5 μm.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Comparative Example 3

Photosensitive etching resists were formed on both surfaces of an 80 μm thick SUS304 stainless steel plate. Then, a photomask that was negative-positive inversed mask of the photomask used in Example 1 was employed and pattern exposure was applied to a region other than circular portions having a diameter of 200 μm each. Then, developing treatment was carried out to form an etching resist layer having circular openings, and etching treatment was then carried out to form openings having a diameter of 200 μm each in/through the stainless steel plate. The etching resist layer on one surface alone was removed to make a resin-formed screen printing mask. That is, the etching resist layer that had not been removed from the other surface was used as a resin layer.

Openings of the thus-obtained resin-formed screen printing mask were observed through a microscope, and as a result, there was found no deviation in the positions of centroids of opening forms of the screen printing mask and the resin layer. An edge portion of the resin layer projected over an inside of the edge portion of opening of the screen printing mask and had the form of a eaves.

When cream solder as a paste material 8 was screen-printed with a squeegee 7 using the above-obtained resin-formed screen printing mask 4 as shown in FIG. 6, a passing failure of the paste material 8, which was thought to be caused by the form of a eaves, took place. Further, when printing was repeatedly carried out on a plurality of substrates, the resin layer formed of the etching resist layer chipped off, and a printing failure, which changed a solder terminal pattern, took place.

### Example 5

A 0.2 mm thick SUS304 stainless steel plate was employed as a substrate for an additive (electroforming) method, and nickel was plated on the substrate to form a nickel layer (thickness 60 μm). Then, a photoresist was applied to a necessary portion on the nickel layer surface. Pattern exposure was carried out through a photomask of a predetermined mesh pattern, and developing treatment was carried out to leave photoresist only in positions corresponding to hole portions in the form of mesh. An iron alloy was plated on the nickel layer surface other than photoresist-remaining portions such that the thickness of a plating did not exceed the thickness of the photoresist, to form a metal mesh layer (thickness 20 μm). Then, the surface formed of the metal mesh layer and the photoresist layer was polished to carry out flattening treatment. Then, the substrate was removed. A photosensitive etching resist layer was formed on the entire surface of the nickel layer, and then pattern exposure was carried out through a photomask corresponding to an opening pattern, followed by developing treatment, whereby an etching resist layer was formed on the nickel layer surface. Then, an exposed nickel layer was etched by etching treatment to make a metal mask openings having the form of a 200 μm×100 mm slit each. The photoresist and etching resist layer used for the plating were finally removed to make a screen printing mask formed of a solid mask having a mesh layer and a metal mask layer.

Then, a resin layer was formed on the metal mask layer in the same manner as in Example 1 to make a resin-formed screen printing mask.

Openings of the thus-obtained resin-formed screen printing mask were observed through a microscope, and as a result, there was found no deviation in the positions of centroids of opening forms of the screen printing mask and the resin layer.

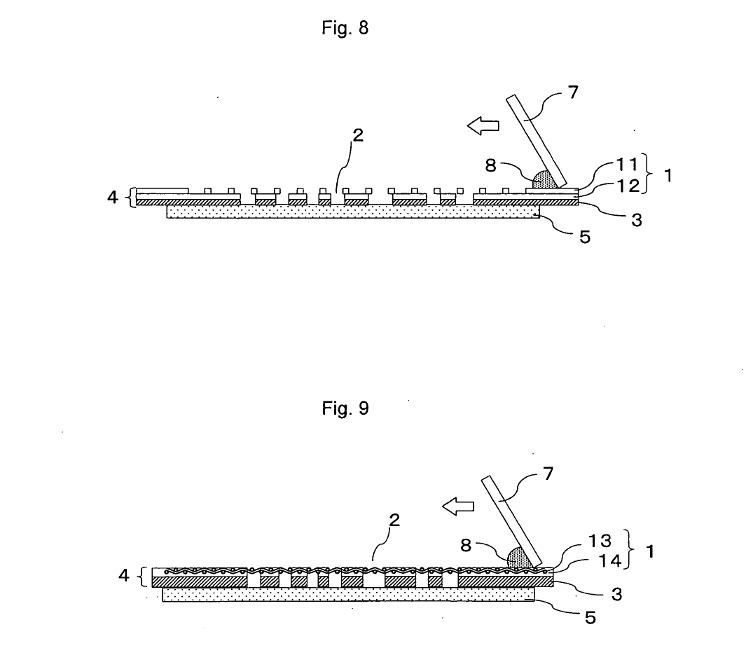

When cream solder as a paste material 8 was screen-printed with a squeegee 7 using the above-obtained resin-formed screen printing mask 4 as shown in FIG. 8, there was no bleeding of cream solder, and a solder terminal pattern having an excellent form could be formed.

### Example 6

As a screen printing mask, a metal mask according to an additive method was made in the same manner as in Example 1. A resin film formed of a resin layer (thickness 20 μm) formed from components shown in Table 1 and a 25 μm thick masking layer (support film, material: polyester) was thermally bonded to one main surface of the metal mask with a laminator, to form the resin layer and the masking layer (support film).

Then, the masking layer was peeled off, and then electrodeposition coating with an electrophotographic liquid toner [emulsion obtained by dispersing acrylic resin particles positively charged with a charge controlling agent in an electrically insulating liquid IP solvent 1620 (supplied by Idemitsu Petrochemical Co., Ltd.)] was carried out by applying bias voltage, to coat a resin particle layer on the resin layer surface corresponding to the non-opening of the metal mask. The resin particles are electrically deposited on the resin layer by adjusting the bias voltage such that the resin layer surface on the openings had portions free of the adherence of the resin particles. Then, the resin particles were fixed by heating them at 70° C. for 2 minutes, to form an electrodeposition resin layer.

Then, a resin layer-removing liquid (1 mass % sodium carbonate aqueous solution (30° C.)) was supplied by shower-spraying it from the first surface side, to remove the resin layer on the openings. The treatment was carried out by setting conditions to ensure an offset value of 5 μm.

Then, ultraviolet ray was applied to the resin layer for 300 seconds with a baking high-pressure mercury lamp light source (Unilec URM300, supplied by Ushio, Inc.) having a suction adhesion mechanism. Further, the electrodeposition resin layer was removed with xylene, followed by heating in an oven at 150° C. for 30 minutes, whereby a durability-imparted resin-formed screen printing mask was made.

Openings of the thus-obtained resin-formed screen printing mask were observed through a microscope, and as a result there was found no deviation in the positions of centroids of opening forms of the screen printing mask and the resin layer, and it was found that the resin layer was uniformly formed with an offset width of 5 μm.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Example 7

As a screen printing mask, a metal mask according to an additive method was made in the same manner as in Example 1. A resin film formed of a resin layer (thickness 25 μm) formed from components shown in Table 1 and a 25 μm thick masking layer (support film, material: polyester) was thermally press-bonded to one main surface (to be referred to as “first surface”) of this metal mask with a laminator, and a resin film formed of a resin layer (thickness 5 μm) and a masking layer (support film, material: polyester) was thermally press-bonded to the other main surface (to be referred to as “second surface”) of the metal mask on the opposite side with a laminator.

Then, the thus-prepared product was left at room temperature of 25° C. and then temperature-increased to 80° C. to soften the resin of each resin layer and at the same time to expand air in the openings, whereby the resin layers on the openings were decreased in thickness. Then, both the masking layers were removed. When the resin layer on the openings in the first surface was measured for a thickness, it had a decreased film thickness of 3 μm.

Then, a resin layer-removing liquid (1 mass % sodium carbonate aqueous solution (25° C.)) was supplied from both the first surface and the second surfaces by shower-spraying to carry out treatment for 10 seconds, whereby the resin layer on the second surface and the resin layer on the first surface and on the openings were removed. The resin layer on the first surface except for the formed openings had a thickness of 20 μm. Further, an offset width of 10 μm was attained.

Then, ultraviolet ray was applied to the resin layer for 300 seconds with a baking high-pressure mercury lamp light source (Unilec URM300, supplied by Ushio, Inc.) having a suction adhesion mechanism, followed by heating in an oven at 150° C. for 30 minutes, whereby a durability-imparted resin-formed screen printing mask was made.

Openings of the thus-obtained resin-formed screen printing mask were observed through a microscope, and as a result there was found no deviation in the positions of centroids of opening forms of the screen printing mask and the resin layer, and it was found that the resin layer was uniformly formed with an offset width of 10 μm.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Comparative Example 4

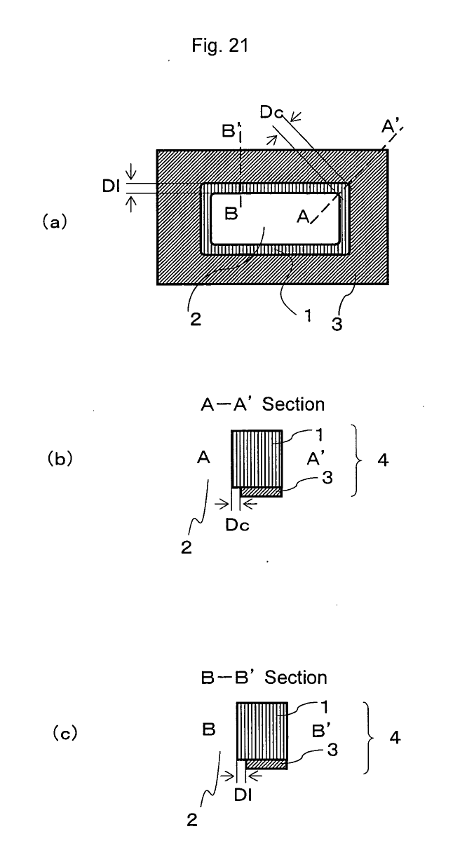

A photoresist (thickness 20 μm) was formed on one main surface (first surface) of a metal mask that had been made as a screen printing mask by a laser method in the same manner as in Example 2. Then, a photomask having a rectangular light-blocking pattern (214 μm×314 μm) formed therein was stacked on the photoresist-formed surface of the metal mask, and the openings of the metal mask and the light-blocking pattern were registered, followed by exposure treatment. However, the rectangular light-blocking pattern on the photomask was aligned with the metal mask with the intention of attaining 7 μm as an offset width D1 in a straight line portion as shown in FIG. 21. Then, developing treatment was carried out to make a resin-formed screen printing mask.

Openings of the thus-obtained resin-formed screen printing mask were observed through a microscope, and as a result there were found a plurality of portions where the deviation in the positions of centroids of opening forms of the screen printing mask and the resin layer was 20 μm or more. Further, there were found some openings which happened to be rightly registered and were free of the deviation in the positions of centroids. In the openings free of the deviation in the positions of centroids, the offset width D1 in a straight line portion was 7 μm and the offset width in corner portions was 18 μm, or Dc<D1 as shown in FIG. 21.

When cream solder as a paste material 8 was screen-printed with a squeegee 7 using the above-obtained resin-formed screen printing mask 4 as shown in FIG. 6, a deviation in printing positions which was thought to be caused by the deviation in the positions took place. Further, the transfer amount of the paste material 8 was insufficient, and a solder terminal pattern having an excellent form could not be formed.

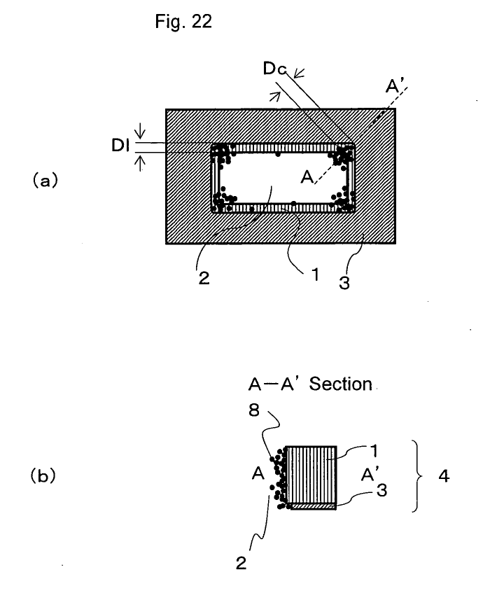

Further, when the resin-formed screen printing mask was observed after the screen printing, the lodging of the paste material 8 in the corner portions 2 of the opening 2 as shown in FIG. 22 was observed in portions free of the deviation in the positions, which was found to be one reason for the insufficient transfer amount.

### Example 8

A photosensitive emulsion for a screen printing mask was applied to a stainless steel mesh screen, and pattern exposure and developing treatment were carried out to make an emulsion type screen printing mask as shown in FIG. 10. It was arranged that the emulsion type screen printing mask had a total thickness of 30 μm. Then, a resin film formed of a resin layer (thickness 50 μm) formed from components shown in Table 1 and a 25 μm thick masking layer (support film, material: polyester) was thermally press-bonded to the emulsion surface (printing surface) (to be referred to as “first surface”) of the screen printing mask with a laminator, to form the resin layer and the masking layer (support film).

Then, the resin layer on the openings was removed in the same manner as in Example 2 by supplying a resin layer-removing liquid. The time period for treatment with the resin layer-removing liquid (a) was adjusted to attain an offset width of 30 μm. Then, the masking layer was removed.

Then, ultraviolet ray was applied to the resin layer for 300 seconds with a baking high-pressure mercury lamp light source (Unilec URM300, supplied by Ushio, Inc.) having a suction adhesion mechanism, followed by heating in an oven at 150° C. for 30 minutes, whereby a durability-imparted resin-formed screen printing mask was made.

Openings of the thus-obtained resin-formed screen printing mask were observed through a microscope, and as a result there was found no deviation in the positions of centroids of opening forms of the screen printing mask and the resin layer, and it was found that the openings were uniformly made with an offset width of 30 μm.

When cream solder as a paste material 8 was screen-printed with a squeegee 7 using the above-obtained resin-formed screen printing mask 4 as shown in FIG. 9, there was no bleeding of cream solder, and a solder terminal pattern having an excellent form could be formed.

### Comparative Example 5

The same emulsion type screen printing mask as that made in Example 8 was employed as a screen printing mask without forming any resin layer, and cream solder was screen-printed on a substrate with it. There was no bleeding of cream solder. Since, however, the screen printing mask had a small thickness of 30 μm, the transfer amount of the cream solder was insufficient and no sufficient solder could be supplied, so that no excellent solder terminal pattern could be formed.

### Example 9

As a screen printing mask, a metal mask according to an additive method was made in the same manner as in Example 1. Then, a sheet obtained by forming 2.5 μm thick thermoplastic polyimide layers on both surfaces of a 15 μm thick polyimide film was employed as a resin layer, and a 3 μm thick copper film as a masking layer was attached to one surface of the resin layer to form a sheet material. The sheet material was thermally press-bonded to one main surface of the metal mask such that the thermoplastic polyimide layer side was in contact with the one main surface.

Then, an aqueous solution containing 33% by mass of N-(β-aminoethyl)ethanolamine, 27% by mass of potassium hydroxide and 1% by mass of ethanolamine was employed as a resin layer-removing liquid (75° C.). This resin layer-removing liquid was supplied from the main surface opposite to the side on which the above resin layer had been formed, to immerse the metal mask therein, and the exposed resin layer formed of the thermoplastic polyimide layers and the polyimide layer was thereby removed. The resin layer was removed by adjusting the treatment time period so as to attain an offset width of 15 μm. Then, etching treatment of copper was carried out to remove the masking layer.

Openings of the thus-obtained resin-formed screen printing mask were observed through a microscope, and as a result it was found that the offset width was uniformly 15 μm. Further, there was found no deviation in the positions of centroids of opening forms of the screen printing mask and the resin layer.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Example 10

Many openings were made in/through a 100 μm thick stainless steel plate (SUS304) with YAG laser to make a metal mask having an area of 400×480 mm.

A resin film formed of a resin layer (thickness 20 μm) formed from components shown in Table 2 and a 25 μm thick masking layer (support film, material: polyester) was thermally press-bonded to one main surface of the above metal mask with a laminator to form the resin layer and the masking layer (support film).

TABLE 2

| Component | | Mass % |
|---|---|---|
| Carboxyl group- | Copolymer having a weight | 55.4 |
| containing binder | average molecular weight of | |
| polymer (A) | 40,000, obtained by | |
| | copolymerization of methyl | |
| | methacrylate/n-butyl | |
| | acrylate/methacrylic acid in | |
| | mass ratio of 64/15/21. (40 | |
| | mass % solution using 1- | |
| | methoxy-2-propanol as solvent) | |
| Photopolymerizable | Dipentaerythritol hexaacrylate | 20 |
| compound (B) | (DPE-500, supplied by KYOEISHA | |
| containing at least | CHEMICAL CO., LTD.) | |
| one polymerizable | | |
| ethylenically | | |
| unsaturated group | | |
| in its molecule | | |
| Photopolymerizable | Ethoxylated bisphenol A | 20 |
| compound (B) | methacrylate (trade name: BPE- | |
| containing at least | 500, supplied by SHIN-NAKAMURA | |
| one polymerizable | CHEMICAL CO., LTD.) | |
| ethylenically | | |
| unsaturated group | | |
| in its molecule | | |
| Photopolymerization | 2-(2′-chlorophenyl)-4,5- | 4.0 |
| initiator (C) | diphenylimidazole dimer | |
| Photopolymerization | 4,4′-bis(diethylamino)- | 0.5 |
| initiator (C) | benzophenone | |
| Pigment | Brilliant Green | 0.1 |

Then, a 1 mass % sodium carbonate aqueous solution (30° C.) removing liquid was employed as a resin layer-removing liquid and shower-sprayed at a spray pressure of 0.2 MPa for 40 seconds from the main surface that the metal surface had opposite to the side on which the resin layer was formed, to partially dissolve and remove the resin layer on the openings of the metal mask and their peripheries, whereby openings were made in/through the resin layer. When the openings in 10 places in the plane of the resin layer and their peripheries were observed through an optical microscope, it was found that the openings having a constant offset width had been made all over in/through the resin layer and the offset width was 20 μm.

Then, ultraviolet ray was applied for 500 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes, whereby a durability-imparted resin-formed metal mask was made.

As shown in FIG. 6, the above-prepared resin-formed metal mask was set on a wiring-printing substrate 5 placed on a pallet, and cream solder 8 was screen-printed with a squeegee 7. There was no bleeding of cream solder between the resin-formed metal mask and the wiring-printing substrate, and a solder terminal having an excellent form was formed. Further, when the resin-formed metal mask was lifted up after the printing, the resin-formed metal mask was excellent in the capability of passing the cream solder through the openings, and none of projections, chipping, cracking and a passing failure were found in the solder terminal. The solder terminal could be formed accurately in a range where the cream solder had to be printed.

### Example 11

Many openings were made in/through a 50 μm thick stainless steel plate (SUS304) with YAG laser to make a metal mask having an area of 400×480 mm.

A resin film formed of a resin layer (thickness 10 μm) formed from components shown in Table 2 and a 25 μm thick masking layer (support film, material: polyester) was thermally press-bonded to one main surface of the above-prepared metal mask having many openings with a laminator to form the resin layer and the masking layer (support film).

Then, a 1 mass % sodium carbonate aqueous solution (30° C.) removing liquid was shower-sprayed at a spray pressure of 0.2 MPa for 20 seconds from the main surface that the metal mask had opposite to the side on which the resin layer was formed, to partially dissolve and remove the resin layer on the openings of the metal mask and their peripheries, whereby openings were made in/through the resin layer. When the openings in 10 places in the plane of the resin layer and their peripheries were observed through an optical microscope, it was found that the openings having a constant offset width had been made all over in/through the resin layer and the offset width was 10 μm.

Then, ultraviolet ray was applied for 300 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes, whereby a durability-imparted resin-formed metal mask was made.

When cream solder was screen-printed with the above-prepared resin-formed metal mask in the same manner as in Example 10, there was no bleeding of cream solder between the resin-formed metal mask and the wiring-printing substrate, and a solder terminal having an excellent form was formed. Further, when the resin-formed metal mask was lifted up after the printing, the resin-formed metal mask was excellent in the capability of passing the cream solder through the openings, and none of projections, chipping, cracking and a passing failure were found in the solder terminal. The solder terminal could be formed accurately in a range where the cream solder had to be printed.

### Example 12

As a substrate for an additive (electroforming) method, a 0.2 mm thick SUS304 stainless steel plate was employed, and a 100 μm thick photosensitive plating resist layer was formed on the surface thereof. Pattern exposure and developing treatment were carried out to form a plating resist pattern corresponding to a printing pattern on the substrate surface. The substrate having the plating resist pattern formed thereon was immersed in a nickel sulfamate bath and subjected to electroplating under conditions of 2 A/dm² and a bath temperature of 45° C., to form a 80 μm thick nickel layer. Then, the plating resist pattern was removed, and the nickel layer was peeled off the substrate to make a metal mask according to an additive method, which was formed of the nickel layer having openings in the form of a pattern.

A resin film formed of a resin layer (thickness 20 μm) formed from components shown in Table 2 and a 25 μm thick masking layer (support film, material: polyester) was thermally press-bonded to one main surface of the above-prepared metal mask with a laminator to form the resin layer and the masking layer (support film).

Then, a resin layer-removing liquid of 1 mass % sodium carbonate aqueous solution (30° C.) removing liquid was shower-sprayed from the main surface that the metal mask had opposite to the side on which the resin layer was formed, to partially dissolve and remove the resin layer that was in contact with the openings of the metal mask. The offset value was set at 20 μm, and the treatment was carried out such that the edge of opening of the resin layer came to be 20 μm outside and apart from the edge of opening of the metal mask.

Then, ultraviolet ray was applied for 500 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes, whereby a durability-imparted resin-formed screen printing mask was made.

Openings of the thus-completed resin-formed screen printing mask were observed through a microscope, and as a result it was found that the deviation in the positions of centroids of the openings of the original screen printing mask and the resin layer was 3 μm or less.

When cream solder as a paste material 8 was screen-printed with a squeegee 7 using the above-obtained resin-formed screen printing mask as shown in FIG. 6, there was no bleeding of cream solder, and a solder terminal pattern having an excellent form could be formed.

### Example 13

Many openings were formed in/through a 80 μm thick stainless steel plate (SUS304) with YAG laser to make a screen printing mask. Thereafter, Example 12 was repeated to make a resin-formed screen printing mask.

Openings of the thus-completed resin-formed screen printing mask were observed through a microscope, and as a result it was found that the deviation in the positions of centroids of the opening forms of the original screen printing mask and the resin layer was 3 μm or less.

When cream solder as a paste material 8 was screen-printed with a squeegee 7 using the above-obtained resin-formed screen printing mask as shown in FIG. 6, there was no bleeding of cream solder, and a solder terminal pattern having an excellent form could be formed.

### Comparative Example 6

A screen printing mask was made in the same manner as in Example 13 except that a 100 μm thick stainless steel plate (SUS304) was used and that the resin layer was not formed. When screen printing was carried out with this mask, it was found that bleeding as shown in FIG. 16(b) took place in some places.

### Comparative Example 7

A resin layer (thickness 20 μm) formed from components shown in Table 2 was formed on a 80 μm thick stainless steel plate (SUS304). Then, holes were made in/through both the resin layer and the stainless steel plate with YAG laser to form openings.

Openings of the thus-completed resin-formed screen printing mask were observed through a microscope, and as a result, it was found that the resin layer was thermally deformed, and there were places where a deviation of 50 μm or more in the deviation of contours took place.

When cream solder as a past material 8 was screen-printed with a squeegee 7 using the above-prepared resin-formed screen printing mask as shown in FIG. 6, the bleeding, which was thought to be caused by the deformation of the resin layer, took place, and a printing in an excellent form could not be carried out.

### Example 14

Photosensitive etching resists were formed on both the surfaces of a 80 μm thick SUS304 stainless steel plate. Then, exposure corresponding to an opening pattern was applied to both the surfaces, and then developing treatment was carried out to make a screen printing mask having openings. Then, the etching resist layers were removed, and then a resin layer was formed in the same manner as in Example 12 to make a resin-formed screen printing mask.

Openings of the thus-completed resin-formed screen printing mask were observed through a microscope, and as a result it was found that the deviation in the positions of centroids of the openings of the original screen printing mask and the resin layer was 3 μm or less.

When cream solder as a paste material 8 was screen-printed with a squeegee 7 using the above-obtained resin-formed screen printing mask as shown in FIG. 6, there was no bleeding of cream solder, and a solder terminal pattern having an excellent form could be formed.

### Example 15

The used resin-formed screen printing mask, which had been used for the screen printing in Example 12, was treated with a 3 mass % sodium hydroxide aqueous solution thereby to peel off the resin layer. Then, a resin layer was again formed in the same manner as in Example 2, to make a resin-formed screen printing mask.

Openings of the thus-completed resin-formed screen printing mask were observed through a microscope, and as a result it was found that the deviation in the positions of centroids of the openings of the original screen printing mask and the resin layer was 3 μm or less.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Comparative Example 8

In Example 14, the etching resist layer on one surface alone was removed, and a resin-formed screen printing mask was made without practicing the formation of a resin layer, etc, thereafter. That is, the etching resist layer that was not removed from the other surface was used as a resin layer.

Openings of the thus-completed resin-formed screen printing mask were observed through a microscope, and as a result it was found that the deviation in the positions of centroids of the openings of the original screen printing mask and the resin layer was 3 μm or less. However, the contour of the resin layer projected over an inside of the edge portion of opening of the screen printing mask in the form of a eaves.

When cream solder as a paste material 8 was screen-printed with a squeegee 7 using the above-obtained resin-formed screen printing mask as shown in FIG. 6, a passing failure (transfer failure) which was thought to be caused by the form of a eaves took place. Further, when printing was repeatedly carried out on a plurality of substrates, defects such as a chipping, etc., took place in the resin layer formed of the etching resist layer, and hence no solder terminal pattern having a good form could be formed.

### Example 16

Nickel was plated on a substrate to form a nickel layer. Then, a photoresist was applied to a necessary portion of the nickel layer surface, and a photomask of a predetermined mesh pattern was attached such that the photoresist was to remain only in positions corresponding to hole portions having the form of mesh, followed by exposure and development. Then, an iron alloy was plated on the nickel layer surface other than photoresist-remaining portions such that the thickness of a plating did not exceed the thickness of the photoresist, to form a metal mesh layer. Then, the surface formed of the metal mesh layer and the photoresist layer was flattened by polishing, and then, the substrate was removed. A photosensitive etching resist layer was formed on the entire surface of the nickel layer, and then exposure corresponding to an opening pattern was carried out, followed by developing treatment, whereby an etching resist layer was formed on the nickel layer surface. Then, an exposed nickel layer was etched by etching treatment to make a metal mask having openings for printing. Finally, the photoresist and etching resist layer used for the plating were removed thereby to make a screen printing mask having a mesh layer and a metal mask layer.

Then, a resin layer was formed in the same manner as in Example 12 to make a resin-formed screen printing mask.

Openings of the thus-completed resin-formed screen printing mask were observed through a microscope, and as a result it was found that the deviation in the positions of centroids of the openings of the original screen printing mask and the resin layer was 3 μm or less.

When cream solder as a paste material 8 was screen-printed with a squeegee 7 using the above-obtained resin-formed screen printing mask 4 as shown in FIG. 8, there was no bleeding of cream solder, and a solder terminal pattern having an excellent form could be formed.

### Example 17

A 0.2 mm thick SUS304 stainless steel plate was employed as a substrate for an additive (electroforming) method, and a 100 μm thick photosensitive plating resist layer was formed on the surface thereof. Pattern exposure and developing treatment were carried out to form a plating resist pattern corresponding to a printing pattern on the substrate surface. The substrate with the above plating resist pattern formed thereon was immersed in a nickel sulfamate plating bath and electroplating was carried out under conditions of 2 A/dm² and a bath temperature of 45° C., to form a 80 μm thick nickel layer. Then, the plating resist pattern was removed, and the nickel layer was peeled off the substrate to make a metal mask according to an additive method, which was formed of a nickel layer having openings in the form of a pattern.

A resin film formed of a resin layer (thickness 20 μm) formed from components shown in Table 2 and a masking layer (support film, material: polyester) was thermally press-bonded to one main surface of the metal mask with a laminator, to form the resin layer and the masking layer (support film).

Then, the masking layer was peeled off, and then electrodeposition application was carried out with a positively charged toner for a Mitsubishi OPC printing system (“ODP-TW” supplied by Mitsubishi Paper Mills Limited) by applying a bias voltage of +200 V, to coat a toner particle layer on the resin layer on a portion other than the openings of the metal mask. The toner particles were electrodeposited on the resin layer such that the resin layer portions positioned on the openings of the metal mask had a region to which no toner particles adhered. Then, the toner particles were fixed by heating at 70° C. for 2 minutes to form an electrodeposition resin layer.

Then, a resin layer-removing liquid was supplied from the side where the resin layer and electrodeposition layer of the metal mask were formed, by shower spraying, to remove the resin layer on the openings. The treatment was carried out by setting conditions to ensure an offset value of 5 μm.

Then, ultraviolet ray was applied to the resin layer for 500 seconds with a baking high-pressure mercury lamp light source (Unilec URM300, supplied by Ushio, Inc.) having a suction adhesion mechanism. Further, the electrodeposition resin layer was removed with xylene, followed by heating in an oven at 120° C. for 30 minutes, whereby a durability-imparted resin-formed screen printing mask was made.

Openings of the thus-completed resin-formed screen printing mask were observed through a microscope, and as a result it was found that the deviation in the positions of centroids of the opening forms of the original screen printing mask and the resin layer was 3 μm or less.

When cream solder as a paste material 8 was screen-printed with a squeegee 7 using the above-obtained resin-formed screen printing mask as shown in FIG. 6, there was no bleeding of cream solder, and a solder terminal pattern having an excellent form could be formed.

### Example 18

A 0.2 mm thick SUS304 stainless steel plate was employed as a substrate for an additive (electroforming) method, and a 100 μm thick photosensitive plating resist layer was formed on the surface thereof. Pattern exposure and developing treatment were carried out to form a plating resist pattern corresponding to a printing pattern on the substrate surface. The substrate with the above plating resist pattern formed thereon was immersed in a nickel sulfamate plating bath and electroplating was carried out under conditions of 2 A/dm² and a bath temperature of 45° C., to form a 80 μm thick nickel layer. Then, the plating resist pattern was removed, and the nickel layer was peeled off the substrate to make a metal mask according to an additive method, which was formed of a nickel layer having openings in the form of a pattern.

Then, a resin film formed of a resin layer (thickness 25 μm) formed from components shown in Table 2 and a 25 μm thick masking layer (support film, material: polyester) was thermally press-bonded to one main surface (to be referred to as “first surface”) of the metal mask with a laminator, and a resin film formed of a resin layer (thickness 5 μm) and a masking layer (support film, material: polyester) was thermally press-bonded to the other main surface (to be referred to as “second surface”) of the metal mask with a laminator.

Then, the thus-prepared product was left at room temperature of 25° C. and then temperature-increased to 80° C. to soften the resin of each resin layer and at the same time to expand air in the openings, whereby the resin layers on the openings were decreased in thickness. Then, both the masking layers were removed. When the resin layer on the openings in the first surface was measured for a thickness, it had a decreased film thickness of 3 μm.

Then, the resin layer on the second surface and the resin layer on the metal mask openings in the first surface were removed by carrying out treatment with a resin layer-removing liquid for a short period of time. The resin layer on the first surface excluding the openings had a thickness of 20 μm. Further, it was found that the offset width was 10 μm.

Then, ultraviolet ray was applied for 500 seconds with a baking high-pressure mercury lamp light source (Unilec URM300, supplied by Ushio, Inc.) having a suction adhesion mechanism, followed by heating in an oven at 120° C. for 30 minutes, whereby a durability-imparted resin-formed screen printing mask was made.

Openings of the thus-completed resin-formed screen printing mask were observed through a microscope, and as a result it was found that the deviation in the positions of centroids of opening forms of the original screen printing mask and the resin layer was 3 μm or less.

When cream solder as a paste material 8 was screen-printed with a squeegee 7 using the above-obtained resin-formed screen printing mask 4 as shown in FIG. 6, there was no bleeding of cream solder, and a solder terminal pattern having an excellent form could be formed.

### Comparative Example 9

In the same manner as in Example 12, a photoresist was formed on one main surface (first surface) of a metal mask made according to an additive method. Then, a photomask corresponding to an opening pattern was stacked on the photoresist-formed surface of the metal mask, and these two were registered, followed by exposure treatment. Then, developing treatment was carried out to make a resin-formed screen printing mask having a resin layer formed on a region other than the openings of the metal mask.

When openings of the thus-completed resin-formed screen printing mask were observed through a microscope, and as a result it was found that there were places where the deviation in positions of centroids of openings of the original metal mask and the resin layer was 20 μm or more.

When cream solder as a paste material 8 was screen-printed with a squeegee 7 using the above-obtained resin-formed screen printing mask as shown in FIG. 6, the deviation in printing position, which was thought to be caused by the positional deviation, took place, and a solder terminal pattern having an excellent form could not be formed.

### Example 19

A photosensitive emulsion for a screen printing mask was applied to a stainless mesh screen, and pattern exposure and developing treatment were carried out to make an emulsion type screen printing mask as shown in FIG. 10. Conditions were set to ensure a thickness of 30 μm. Then, a resin film formed of a resin layer (thickness 50 μm) formed from components shown in Table 2 and a 25 μm thick masking layer (support film, material: polyester) was thermally press-bonded to the emulsion surface (printing surface) (to be referred to as “first surface”) of the above screen printing mask to form the resin layer and the masking layer (support film).

Then, a 1 mass % sodium carbonate aqueous solution (30° C.) was employed as a resin layer-removing liquid and shower-sprayed from the main surface (to be referred to as second surface) opposite to the first surface of the screen printing mask to dissolve and remove the resin layer on the openings in the first surface side. The offset value was set at 30 μm, and the treatment was carried out such that the edge of opening of the resin layer came to be 30 μm outside and apart from the edge of opening in the emulsion surface of the screen printing mask.

Then, ultraviolet ray was applied for 500 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes, whereby a durability-imparted resin-formed screen printing mask was made.

Openings of the thus-completed resin-formed screen printing mask were observed through a microscope, and as a result it was found that the deviation in the positions of centroids of opening forms of the original screen printing mask and the resin layer was 3 μm or less.

When cream solder as a paste material 8 was screen-printed with a squeegee 7 using the above-obtained resin-formed screen printing mask 4 as shown in FIG. 9, there was no bleeding of cream solder, and a solder terminal pattern having an excellent form could be formed.

### Comparative Example 10

The same emulsion type screen printing mask as that made in Example 19 was employed without forming a resin layer, and cream solder was screen-printed on a substrate with the emulsion type screen printing mask. There was no bleeding of cream solder. Since, however, the screen printing mask had a small thickness of 30 μm, the transfer amount of the cream solder was insufficient, no sufficient amount of the cream solder could be supplied, and no excellent solder terminal pattern could be formed.

### Example 20

A 0.2 mm thick SUS304 stainless steel plate was employed as a substrate for an additive method, and a 100 μm thick photosensitive plating resist layer was formed on the surface thereof. Pattern exposure and developing treatment were carried out to form a plating resist pattern corresponding to circular patterns having four different hole diameters of 0.1 mmφ, 0.5 mmφ, 1.0 mmφ and 10.0 mmφ on the substrate surface. The substrate having these plating resist patterns formed thereon was immersed in a nickel sulfamate plating batch and electroplating was carried out under conditions of 2 A/dm² and a bath temperature of 45° C., to form a 100 μm thick nickel layer. Then, the plating resist pattern was removed and the nickel layer was peeled off the substrate, to make a metal mask according to an additive method, which had openings in the form of four circular patterns having different hole diameters.

A resin film formed of a resin layer (thickness 20 μm) formed from components shown in Table 2 and a masking layer (support film, material: polyester) was thermally press-bonded to one main surface of the metal mask having the openings in the form of four circular patterns having different hole diameters with a laminator, to form the resin layer and the masking layer (support film).

Then, a resin layer-removing liquid (a) described in Table 3 was employed and shower-sprayed from the main surface of the substrate opposite to the side where the resin layer and the masking layer were formed, at a spraying pressure of 0.2 MPa for 30 seconds. When the resin layer on the openings in the first surface and peripheries to the openings was visually observed for dissolution and diffusion, no dissolution was observed, and it was found that the micelle of the resin layer had been insolubilized.

TABLE 3

| | | | | | Offset width |
|---|---|---|---|---|---|
| | | | | | (Difference |
| | | | | | between |
| | | Amount | | Amount | diameters of |
| | Resin layer- | (Part | Resin layer- | (Part | removed |
| | removing | by | removing | by | portions in |
| | liquid (a) | mass) | liquid (b) | mass) | resin layer) |
| Example | Sodium | 10 | Sodium | 1 | 19 |
| 20 | carbonate | | carbonate | | |
| | Water | 90 | Water | 99 | |
| Example | Sodium | 10 | Sodium | 1 | 20 |
| 21 | phosphate | | carbonate | | |
| | Water | 90 | Water | 99 | |
| Example | Sodium | 10 | Sodium | 1 | 25 |
| 22 | hydroxide | | carbonate | | |
| | Water | 90 | Water | 99 | |
| Example | Sodium | 10 | Sodium | 1 | 22 |
| 23 | silicate | | carbonate | | |
| | Water | 90 | Water | 99 | |
| Example | Sodium | 5 | Sodium | 1 | 28 |
| 24 | carbonate | | carbonate | | |
| | Water | 95 | Water | 99 | |
| Example | Sodium | 7 | Sodium | 1 | 25 |
| 25 | carbonate | | carbonate | | |
| | Water | 93 | Water | 99 | |
| Example | Sodium | 15 | Sodium | 1 | 18 |
| 26 | carbonate | | carbonate | | |
| | Water | 85 | Water | 99 | |
| Example | Sodium | 20 | Sodium | 1 | 18 |
| 27 | carbonate | | carbonate | | |
| | Water | 80 | Water | 99 | |
| Example | Sodium | 10 | Water | 100 | 19 |
| 28 | carbonate | | | | |
| | Water | 90 | | | |
| Example | Sodium | 10 | Sodium | 4 | 35 |
| 29 | carbonate | | carbonate | | |
| | Water | 90 | Water | 96 | |
| Example | Sodium | 10 | Tetramethyl | 1 | 45 |
| 30 | carbonate | 90 | ammonium | 99 | |
| | Water | | hydroxide | | |
| | | | Water | | |
| Example | Sodium | 10 | Sodium | 1 | 21 |
| 31 | carbonate | | phosphate | | |
| | Water | 90 | Water | 99 | |
| Example | Sodium | 10 | Sodium | 1 | 26 |
| 32 | carbonate | | hydroxide | | |
| | Water | 90 | Water | 99 | |
| Example | Sodium | 10 | Sodium | 1 | 23 |
| 33 | carbonate | | silicate | | |
| | Water | 90 | Water | 99 | |
| Example | Sodium | 10 | Sodium | 3 | 19 |
| 34 | carbonate | | carbonate | | |
| | Water | 90 | Water | 97 | |
| Example | Potassium | 10 | Sodium | 1 | 21 |
| 35 | carbonate | | carbonate | | |
| | Water | 90 | Water | 99 | |
| Example | Potassium | 5 | Sodium | 1 | 30 |
| 36 | carbonate | | carbonate | | |
| | Water | 95 | Water | 99 | |
| Example | Potassium | 20 | Sodium | 1 | 21 |
| 37 | carbonate | | carbonate | | |
| | Water | 80 | Water | 99 | |
| Example | Sodium | 10 | Sodium | 1 | 19 |
| 38 | carbonate | | carbonate | | |
| | Water | 90 | Water | 99 | |
| Example | Sodium | 10 | Sodium | 1 | 20 |
| 39 | carbonate | | carbonate | | |
| | Water | 90 | Water | 99 | |
| Example | Sodium | 10 | Sodium | 1 | 19 |
| 40 | carbonate | | carbonate | | |
| | Water | 90 | Water | 99 | |

Then, a resin layer-removing liquid (b) (30° C.) was employed and shower-sprayed at a spraying pressure of 0.2 MPa for 10 seconds from the side opposite to the side of the substrate where the resin layer and the masking layer were formed, to again solubilize and remove the insolubilized micelle of the resin layer present on the openings of the metal mask and peripheries of the openings on the side of the substrate where the resin layer and the masking layer were formed. When the openings of the metal mask and peripheries of the openings were observed through an optical microscope, it was found that the resin layer in the peripheries of the openings had been removed concentrically with the openings of the metal mask. Further, it was found that the diameters of resin-layer-removed portions relative to those openings of the metal mask which were of circular patterns having different diameters of from a minimum diameter of 0.1 mmφ to a maximum diameter of 10.0 mmφ tended to increase with an increase in the diameters of the openings of the metal mask. And, the diameters of openings as the resin-layer-removed portions corresponding to the minimum diameter of 0.1 mmφ and the maximum diameter of 10.0 mmφ were different from each other by 19 μm.

Then, ultraviolet ray was applied to the resin layer having the openings formed therein for 500 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes, whereby a durability-imparted resin-formed screen printing mask was made.

The above-prepared resin-formed metal mask was set on a wiring-printing substrate 5 placed on a pallet, and cream solder 8 was screen-printed with a squeegee 7 as shown in FIG. 6. There was no bleeding of cream solder 8 between the resin-formed screen printing mask and the wiring-printing substrate with regard to all of the openings of four circular patterns having different diameters, and a solder terminal having an excellent form was formed. Further, when the resin-formed screen printing mask was lifted up after the printing, the resin-formed screen printing mask was excellent in the capability of passing the cream solder 8 through the openings, and none of projections, chipping, cracking and a passing failure were found in the solder terminal. The solder terminal could be formed accurately in a range where the cream solder had to be printed.

### Examples 21′-37

In Examples 21 to 27 and 35 to 37, the same resin layer as that of Example 20 on openings in the form of four circular patterns having different hole diameters and peripheries of the openings was removed in the same manner as in Example 20 except that the resin layer-removing liquid (a) described in Example 20 was replaced with a resin layer-removing liquid (a) described in Table 3.

In Examples 28 and 30 to 34, the same resin layer as that of Example 20 on openings in the form of four circular patterns having different hole diameters and peripheries of the openings was removed in the same manner as in Example 20 except that the resin layer-removing liquid (b) described in Example 20 was replaced with a resin layer-removing liquid (b) described in Table 3.

In Example 29, the same resin layer as that of Example 20 on openings in the form of four circular patterns having different hole diameters and peripheries of the openings was removed in the same manner as in Example 1 except that the resin layer-removing liquid (b) described in Example 20 was replaced with a resin layer-removing liquid (b) described in Table 3 and that the time period for the treatment of the resin layer was extended from 10 seconds to 30 seconds. In each Example, when the openings of the metal mask and peripheries of the openings were observed through an optical microscope, it was found that the resin layer in the peripheries of the openings had been removed concentrically with the openings. Table 3 shows a difference between diameters of openings of the resin-layer-removed portions corresponding to a minimum diameter of 0.1 mmφ and a maximum diameter of 10.0 mmφ of the openings of the metal mask.

In Examples 20 and 24 to 27, the amounts of sodium carbonate in the resin layer-removing liquids a were changed, and as a result, and it was found that the difference between diameters of the resin-layer-removed portions tends to decrease with an increase in the amount of sodium carbonate.

In Examples 20, 28-29 and 34, the amounts of sodium carbonate in the resin layer-removing liquids b were changed, while there was almost no difference between diameters of the resin layer-removed portions except for Example 29.

In Example 29, an insolubilized micelle after the supply of resin layer-removing liquid (a) was slow in being dissolved and diffused, and when the time period for the treatment with the resin layer-removing liquid (b) was extended from 10 seconds to 30 seconds to remove the resin layer, the difference between diameters of resin layer-removed portions tended to increase as compared with Examples 20, 28 and 34. In Example 30, when tetramethylammonium hydroxide which was an organic alkaline compound was used as a resin layer-removing liquid (b), an insolubilized micelle after the supply of the resin layer-removing liquid (a) was rapidly finely dispersed, while a resin layer other than the insolubilized portion underwent dissolution and diffusion at the same time and the difference between diameters of resin layer-removed portions tended to increase.

In Examples 21 to 23, when alkaline compounds other than sodium carbonate were used as a resin layer-removing liquid (a), the difference between diameters of resin layer-removed portions tended to increase to some extent in the system using sodium hydroxide as compared with the use of sodium carbonate, sodium phosphate and sodium silicate. In Examples 31 to 33, further, when an alkaline compound other than sodium carbonate was used as a resin layer-removing liquid, the difference between diameters of resin-layer-removed portion tended to increase in the system using sodium hydroxide as a resin layer-removing liquid (b) like the cases of Examples 21 to 23. In Examples 35 to 37, when potassium was used as an alkali metal in place of sodium, the difference between diameters of resin layer-removed portions tended to slightly increase in the system using an alkali metal carbonate as a resin layer-removing liquid (a).

In each Example, then, ultraviolet ray was applied to the resin layer having the openings formed therein for 500 seconds with a baking high-pressure mercury lamp light source (Unilec URM300, supplied by Ushio, Inc.) having a suction adhesion mechanism. Further, the masking layer was removed, followed by heating in an oven at 120° C. for 30 minutes. In this manner, durability-imparted resin-formed screen printing masks were made.

In each Example, the above-prepared resin-formed screen printing mask was set on a wiring-printing substrate 5 placed on a pallet, and cream solder 8 was screen-printed with a squeegee 7 as shown in FIG. 6. There was no bleeding of cream solder 8 with regard to all of the openings of four circular patterns having different diameters, and a solder terminal having an excellent form could be formed.

### Example 38

Many openings were made in/through a 100 μm thick stainless steel plate (SUS304) with YAG laser to make a screen printing mask. Thereafter, a resin-formed screen printing mask was made in the same manner as in Example 20. Table 3 shows a difference between diameters of resin-layer-removed portions corresponding to a minimum diameter of 0.1 mmφ and a maximum diameter of 10.0 mmφ of openings of the metal mask.

The above-prepared resin-formed screen printing mask was set on a wiring-printing substrate 5 placed on a pallet, and cream solder 8 was screen-printed with a squeegee 7 as shown in FIG. 6. There was no bleeding of cream solder 8 with regard to all of the openings of four circular patterns having different diameters, and a solder terminal having an excellent form could be formed.

### Example 39

Photosensitive etching resists were formed on both the surfaces of a 100 μm thick SUS304 stainless steel plate, exposure corresponding to an opening pattern was applied to both the surfaces and then developing treatment was carried out to make a screen printing mask having openings. Then, the etching resist layers were removed, and thereafter the screen printing mask was treated in the same manner as in Example 20 to make a resin-formed screen printing mask. Table 3 shows a difference between diameters of resin layer-removed portions corresponding to a minimum diameter of 0.1 mmφ and a maximum diameter of 10.0 mmφ of openings of the metal mask.

The above-prepared resin-formed screen printing mask was set on a wiring-printing substrate 5 placed on a pallet, and cream solder 8 was screen-printed with a squeegee 7 as shown in FIG. 6. There was no bleeding of cream solder 8 with regard to all of the openings of four circular patterns having different diameters, and a solder terminal having an excellent form could be formed.

### Example 40

Nickel was plated on a substrate to form a nickel layer. Then, a photoresist was applied to a necessary portion of the nickel layer surface, and a photomask of a predetermined mesh pattern was attached such that the photoresist was to remain only in positions corresponding to hole portions having the form of mesh, followed by exposure and development. Then, an iron alloy was plated on the nickel layer surface other than photoresist-remaining portions such that the thickness of a plating did not exceed the thickness of the photoresist, to form a metal mesh layer. Then, the surface formed of the metal mesh layer and the photoresist layer was flattened by polishing, and the substrate was removed. A photosensitive etching resist layer was formed on the entire surface of the nickel layer, and then exposure corresponding to an opening pattern was carried out, followed by developing treatment, whereby an etching resist layer was formed on the nickel layer surface. Then, an exposed nickel layer was etched by etching treatment to make a metal mask having openings for printing. Finally, the photoresist and etching resist layer used for the plating were removed thereby to make a screen printing mask having a mesh layer and a metal mask layer. Thereafter, the screen printing mask was treated in the same manner as in Example 20 to make a resin-formed screen printing mask. Table 3 shows a difference between diameters of resin-layer-removed portions of a minimum diameter of 0.1 mmφ and a maximum diameter of 10.0 mmφ.

The above-prepared resin-formed screen printing mask was set on a wiring-printing substrate 5 placed on a pallet, and cream solder 8 was screen-printed with a squeegee 7 as shown in FIG. 6. There was no bleeding of cream solder 8 with regard to all of the openings of four circular patterns having different diameters, and a solder terminal having an excellent form could be formed.

### Examples 41-60

### 1. Preparation of Photo-Crosslinkable Resin Solution

Components including carboxyl group-containing binder polymers (A), photopolymerizable compounds (B) having at least one polymerizable ethylenically unsaturated group in its molecule and photopolymerization initiators (C) as shown in Tables 4 and 5 were mixed to prepare photo-crosslinkable resin solutions for use in Examples 41 to 60.

In Tables 4 and 5, values in lines of components stand for amounts of components based on part by mass, and values in lines of components (A) stand for amounts of solutions based on part by mass.

TABLE 4

| | | Ex. | Ex. | Ex. | Ex. | Ex. | Ex. | Ex. | Ex. | Ex. | Ex. | Ex. |
|---|---|---|---|---|---|---|---|---|---|---|---|---|
| Component | | 41 | 42 | 43 | 44 | 45 | 46 | 47 | 48 | 49 | 50 | 51 |
| Component A | A-1 | 150 | 200 | 150 | 75 | 150 | 150 | 150 | 150 | 150 | 150 | 150 |
| | A-2 | | | | | | | | | | | |
| | A-3 | | | | | | | | | | | |
| | A-4 | | | | | | | | | | | |
| | A-5 | | | | | | | | | | | |
| | A-6 | | | | | | | | | | | |
| | A-7 | | | | | | | | | | | |
| | A-8 | | | | | | | | | | | |
| Component B | B-1 | 20 | 8 | 10 | 8 | 0 | 5 | 5 | 5 | 5 | 5 | 5 |
| | B-2 | 20 | 12 | 30 | 62 | 40 | 35 | | | | | |
| | B-3 | | | | | | | 35 | | | | |
| | B-4 | | | | | | | | 35 | | | |
| | B-5 | | | | | | | | | 35 | | |
| | B-6 | | | | | | | | | | 35 | |
| | B-7 | | | | | | | | | | | 35 |
| | B-8 | | | | | | | | | | | |
| | B-9 | | | | | | | | | | | |
| C'nt C | C-1 | 4 | 4 | 4 | 4 | 4 | 4 | 4 | 4 | 4 | 4 | 4 |
| | C-2 | 0.5 | 0.5 | 0.5 | 0.5 | 0.5 | 0.5 | 0.5 | 0.5 | 0.5 | 0.5 | 0.5 |
| Pigment | Phthalo- | 0.1 | 0.1 | 0.1 | 0.1 | 0.1 | 0.1 | 0.1 | 0.1 | 0.1 | 0.1 | 0.1 |
| | cyanine | | | | | | | | | | | |
| | Green | | | | | | | | | | | |
| Solvent | Methyl | 30 | 30 | 30 | 30 | 30 | 30 | 30 | 30 | 30 | 30 | 30 |
| | ethyl | | | | | | | | | | | |
| | ketone | | | | | | | | | | | |
| | 2- | 30 | 30 | 30 | 30 | 30 | 30 | 30 | 30 | 30 | 30 | 30 |
| | Propanol | | | | | | | | | | | |

Ex. = Example, C'nt = Component

TABLE 5

| | | Ex. | Ex. | Ex. | Ex. | Ex. | Ex. | Ex. | Ex. | Ex. |
|---|---|---|---|---|---|---|---|---|---|---|
| Component | | 52 | 53 | 54 | 55 | 56 | 57 | 58 | 59 | 60 |
| Component A | A-1 | 150 | 150 | | | | | | | |
| | A-2 | | | 150 | | | | | | |
| | A-3 | | | | 150 | | | | | |
| | A-4 | | | | | 150 | | | | |
| | A-5 | | | | | | 150 | | | |
| | A-6 | | | | | | | 150 | | |
| | A-7 | | | | | | | | 150 | |
| | A-8 | | | | | | | | | 150 |
| Component B | B-1 | 5 | 5 | 5 | 5 | 5 | 5 | 5 | 5 | 5 |
| | B-2 | | | 35 | 35 | 35 | 35 | 35 | 35 | 35 |
| | B-3 | | | | | | | | | |
| | B-4 | | | | | | | | | |
| | B-5 | | | | | | | | | |
| | B-6 | | | | | | | | | |
| | B-7 | | | | | | | | | |
| | B-8 | 35 | | | | | | | | |
| | B-9 | | 35 | | | | | | | |
| C'nt C | C-1 | 4 | 4 | 4 | 4 | 4 | 4 | 4 | 4 | 4 |
| | C-2 | 0.5 | 0.5 | 0.5 | 0.5 | 0.5 | 0.5 | 0.5 | 0.5 | 0.5 |
| Pigment | Phthalo- | 0.1 | 0.1 | 0.1 | 0.1 | 0.1 | 0.1 | 0.1 | 0.1 | 0.1 |
| | cyanine | | | | | | | | | |
| | Green | | | | | | | | | |
| Solvent | Methyl | 30 | 30 | 30 | 30 | 30 | 30 | 30 | 30 | 30 |
| | ethyl | | | | | | | | | |
| | ketone | | | | | | | | | |
| | 2- | 30 | 30 | 30 | 30 | 30 | 30 | 30 | 30 | 30 |
| | Propanol | | | | | | | | | |

Ex. = Example, C'nt = Component

In Tables 4 and 5, components (A), components (B) and components (C) are as follows.

Component (A-1): Copolymer resin obtained by copolymerization of methyl methacrylate/n-butyl acrylate/methacrylic acid in a mass ratio of 64/15/21 (40 mass % solution using 1-methoxy-2-propanol as a solvent).

Component (A-2): Copolymer resin obtained by copolymerizing methyl methacrylate/n-butyl acrylate/methacrylic acid in a mass ratio of 60/15/25 and then adding 5 mass %, based on the methacrylic acid, of glycidyl methacrylate (40 mass % solution using 1-methoxy-2-propanol as a solvent).

Component (A-3): Copolymer resin obtained by copolymerizing methyl methacrylate/n-butyl acrylate/methacrylic acid in a mass ratio of 56/15/29 and then adding 10 mass %, based on the methacrylic acid, of glycidyl methacrylate (40 mass % solution using 1-methoxy-2-propanol as a solvent).

Component (A-4): Copolymer resin obtained by copolymerizing methyl methacrylate/n-butyl acrylate/methacrylic acid in a mass ratio of 62/15/23 and then adding 20 mass %, based on the methacrylic acid, of glycidyl methacrylate (40 mass % solution using 1-methoxy-2-propanol as a solvent).

Component (A-5): Copolymer resin obtained by copolymerizing methyl methacrylate/n-butyl acrylate/methacrylic acid in a mass ratio of 51/15/34 and then adding 35 mass %, based on the methacrylic acid, of glycidyl methacrylate (40 mass % solution using 1-methoxy-2-propanol as a solvent).

Component (A-6): Copolymer resin obtained by copolymerizing methyl methacrylate/n-butyl acrylate/methacrylic acid in a mass ratio of 39/15/46 and then adding 50 mass %, based on the methacrylic acid, of glycidyl methacrylate (40 mass % solution using 1-methoxy-2-propanol as a solvent).

Component (A-7): Copolymer resin obtained by copolymerizing methyl methacrylate/n-butyl acrylate/methacrylic acid in a mass ratio of 63/15/22 and then adding 3 mass %, based on the methacrylic acid, of glycidyl methacrylate (40 mass % solution using 1-methoxy-2-propanol as a solvent).

Component (A-8): Copolymer resin obtained by copolymerizing methyl methacrylate/n-butyl acrylate/methacrylic acid in a mass ratio of 32/15/53 and then adding 60 mass %, based on the methacrylic acid, of glycidyl methacrylate (40 mass % solution using 1-methoxy-2-propanol as a solvent).

(B-1) 2,2′-bis-(4-methacryloxypentaethoxyphenyl)-propane (trade name: BPE-500, supplied by SHIN-NAKAMURA CHEMICAL CO., LTD.)

(B-2) Trimethylolpropane triacrylate (trade name: TMP-A, supplied by KYOEISHA CHEMICAL CO., LTD.)

(B-3) Ditrimethylolpropane tetraacrylate

(B-4) Pentaerythritol acrylate (trade name: PE-3A, supplied by KYOEISHA CHEMICAL CO., LTD.)

(B-5) Pentaerythritol tetraacrylate (trade name: PE-4A, supplied by KYOEISHA CHEMICAL CO., LTD.)

(B-6) Dipentaerythritol pentaacrylate

(B-7) Dipentaerythritol hexaacrylate (trade name: DPE-6A, supplied by KYOEISHA CHEMICAL CO., LTD.)

(B-8) Trimethylolpropane triglycidyl ether triacrylate

(B-9) EO-modified trimethylolpropane triacrylate (trade name: TMP-6EO-3A, supplied by KYOEISHA CHEMICAL CO., LTD.)

(C-1) 2-(2′-chlorophenyl)-4,5-diphenylimidazole dimer

(C-2) 4,4′-bis(diethylamino)benzophenone

Table 6 shows physical properties of components (A-1) to (A-8) together with compositions thereof. In Table 6, MMA stands for methyl methacrylate, BA stands for n-butyl acrylate, MAA stands for methacrylic acid, GMA stands for glycidyl methacrylate, Mw stands for a mass average molecular weight of a copolymer resin, and Av stands for an acid value of a copolymer resin.

TABLE 6

| | | | | | Physical properties | | |
|---|---|---|---|---|---|---|---|
| | | | | | | | Double |
| Composition | | | | | | | bond |
| | MMA | BA | MAA | GMA | | | equiva- |
| Component | (Mass | (Mass | (Mass | Mass % | | Av | lent |
| name | ratio) | ratio) | ratio) | (to MAA) | Mw | (MgKOH/g) | weight |
| A-1 | 64 | 15 | 21 | 0 | 26100 | 130 | — |
| A-2 | 60 | 15 | 25 | 5 | 25000 | 135 | 2980 |
| A-3 | 56 | 15 | 29 | 10 | 26400 | 138 | 1560 |
| A-4 | 62 | 15 | 23 | 20 | 23100 | 128 | 850 |
| A-5 | 51 | 15 | 34 | 35 | 23300 | 132 | 550 |
| A-6 | 39 | 15 | 46 | 50 | 22100 | 134 | 430 |
| A-7 | 63 | 15 | 22 | 3 | 24200 | 131 | 3650 |
| A-8 | 32 | 15 | 53 | 60 | 25700 | 130 | 280 |

### 2. Making of Resin-Formed Screen Printing Mask

Openings were made in/through a 100 μm thick stainless steel plate (SUS304) with YAG laser to make a screen printing mask having an area of 400×480 mm.

A photo-crosslinkable resin solution prepared in 1. was uniformly applied onto a 25 μm thick masking layer (support film, material: polyester) and the applied solution was dried to form a photo-crosslinkable resin layer (dry thickness: 20 μm). In this manner, resin films were obtained. The thus-obtained resin film was thermally press-bonded to one main surface (to be referred to as “first surface”) of the above-obtained screen printing mask having many openings, to form a resin layer and a masking layer.

In each Example, then, a resin layer-removing liquid of a 1 mass % sodium carbonate aqueous solution (30° C.) was employed and shower-sprayed to the other main surface (to be referred to as “second surface”) of the screen printing mask opposite to the side where the resin layer and the masking layer were formed, to remove the resin layer on the openings in the first surface and peripheries of the openings by self-alignment. Openings and peripheries of the openings in 10 places in the surface were observed through an optical microscope, and it was found that edge portions of the openings in the resin layer had no burr and that the openings were formed at an edge angle in the range of 90±5 degrees and had an excellent edge portion form. Further, on the entire surface, the openings in the resin layer had no positional deviation, and the resin layer having a constant offset width and a constant thickness was formed.

In each Example, then, ultraviolet ray was applied for 300 seconds with a baking high-pressure mercury lamp light source (Unilec URM300, supplied by Ushio, Inc., 12 mW/cm²) having a suction adhesion mechanism. Further, the masking layer was removed, followed by heating in an oven at 150° C. for 30 minutes. In this manner, durability-imparted resin-formed screen printing masks were made.

### Examples 61-72

Resin-coated screen printing masks were made in the same manner as in Example 46 except that the application of ultraviolet ray and the heating (temperature and time period) were carried out under conditions shown in Table 7 in the step of treating resin layers to impart them with durability after the resin layers on the openings in the first surface and peripheries of the openings were removed by self-alignment. In the thus-obtained resin-formed screen printing masks, edge portions of the openings in each resin layer had no burr and that the openings were formed at an edge angle in the range of 90±5 degrees and had an excellent edge portion form. Further, on the entire surface of each resin layer, the openings in each resin layer had no positional deviation, and the resin layers having a constant offset width (removal width of resin layer) and a constant thickness were formed.

TABLE 7

| | Time period | | | Heating |
|---|---|---|---|---|
| | (second) for | Exposure | Heating | time |
| | application of | dose | temperature | period |
| | ultraviolet ray | (J/cm²) | (° C.) | (minute) |
| Example 61 | 300 | 3.6 | — | — |
| Example 62 | 50 | 0.6 | 150 | 30 |
| Example 63 | 75 | 1.05 | 150 | 30 |
| Example 64 | 210 | 2.94 | 150 | 30 |
| Example 65 | 420 | 5.88 | 150 | 30 |
| Example 66 | 660 | 9.24 | 150 | 30 |
| Example 67 | 1020 | 14.3 | 150 | 30 |
| Example 68 | 1320 | 18.5 | 150 | 30 |
| Example 69 | 300 | 3.6 | 120 | 30 |
| Example 70 | 300 | 3.6 | 170 | 30 |
| Example 71 | 300 | 3.6 | 150 | 10 |
| Example 72 | 300 | 3.6 | 150 | 90 |

### (Evaluation of Transfer Capability)

In each of Examples 41 to 72, the resin-formed screen printing mask was set on a wiring-printing substrate 5 placed on a pallet, and cream solder 8 was screen-printed with a squeegee 7 as shown in FIG. 6. Table 8 shows evaluation results of transfer capability. In Table 8, “o” shows that a resin-formed screen printing mask was excellent in transfer capability, which means that there was no bleeding between the resin-formed screen printing mask and a wiring-printing substrate, that when the resin-formed screen printing mask was lifted up after the printing, it was excellent in capability of passing cream solder through its openings, namely that none of chipping, cracking, passing failure, etc., was found in a solder terminal and that a solder terminal could be accurately formed in a range where cream solder had to be printed. “x” shows a resin-formed screen printing mask that had a problem of bleeding or passing failure as being poor in transfer capability.

### (Evaluation of Solvent Resistance)

The resin-formed screen printing mask made in each of Examples 41 to 72 was set in an ultrasonic direct transmission type metal mask automatic washer (supplied by SAWA CORPORATION) was washed with a mask cleaning liquid (trade name: HA-1040 (a mixture of 1-methoxy-2-propanol with 2-propanol) supplied by Kaken Tech Co., Ltd.) for screen printing masks at an ultrasonic output of 40 kHz at 150 W for 3 minutes and dried for 5 minutes, and these washing and drying were repeated 10 times. Table 8 shows the results of evaluation of the resin layer of each resin-formed screen printing mask for solvent resistance against the cleaning liquid. In Table 8, the evaluation of the solvent resistance was based on whether or not the resin layer underwent cracking, braking or swelling in the entire surface thereof, and how many times the cleaning was carried out until the resin layer failed to maintain durability against the cleaning. Larger values mean that the resin layers are excellent in solvent resistance.

### (Evaluation of Capability of Continuous Printing)

Cream solder was continuously screen-printed on 10 wiring-printing substrates using the resin-formed screen printing mask made in each of Examples 41 to 72, and the transfer capability thereof on the first substrate and that on the 10th substrate were compared. Then, the resin-formed screen printing masks were cleaned by wiping the resin layer surfaces with cleaning paper wet with 2-propanol, cream solder was again continuously screen-printed on 10 wiring-printing substrates using each of the cleaned resin-formed screen printing masks, and the transfer capability on the 10th substrate and that on the 20th substrate were compared. The screen printing and the cleaning treatment were repeated 99 times, and cream solder was continuously printed on 10 wiring-printing substrates using each of the resin-formed screen printing masks that had been cleaned 99 times. The transfer capability thereof on the 10th substrate and that on the 1000th substrate were compared. Table 8 shows the results of evaluation of the continuous printing. Each resin-formed screen printing mask was evaluated for their capability of continuous printing on the basis of whether or not a solder terminal could be formed on a range where cream solder had to be printed, without bleeding of cream solder, and like the evaluation of capability of transfer, Table 8 shows how many times the cleaning was carried out until the resin layer failed to maintain the capability of excellent transfer. Larger values mean that resin-formed screen printing masks are excellent in capability of continuous printing.

TABLE 8

| | | | Capability of |
|---|---|---|---|
| | Capability of | Solvent | continuous |
| | transfer | resistance | printing |
| Example 41 | ∘ | 3 | 45 |
| Example 42 | ∘ | 2 | 26 |
| Example 43 | ∘ | 6 | 90 |
| Example 44 | ∘ | 3 | 38 |
| Example 45 | ∘ | 7 | 99 |
| Example 46 | ∘ | 6 | 99 |
| Example 47 | ∘ | 7 | 99 |
| Example 48 | ∘ | 6 | 99 |
| Example 49 | ∘ | 7 | 99 |
| Example 50 | ∘ | 8 | 99 |
| Example 51 | ∘ | 8 | 99 |
| Example 52 | ∘ | 6 | 99 |
| Example 53 | ∘ | 2 | 31 |
| Example 54 | ∘ | 8 | 99 |
| Example 55 | ∘ | 9 | 99 |
| Example 56 | ∘ | 10 | 99 |
| Example 57 | ∘ | 10 | 99 |
| Example 58 | ∘ | 10 | 99 |
| Example 59 | ∘ | 7 | 99 |
| Example 60 | ∘ | 10 | 99 |
| Example 61 | ∘ | 3 | 50 |
| Example 62 | ∘ | 2 | 33 |
| Example 63 | ∘ | 5 | 92 |
| Example 64 | ∘ | 6 | 99 |
| Example 65 | ∘ | 7 | 99 |
| Example 66 | ∘ | 7 | 99 |
| Example 67 | ∘ | 7 | 99 |
| Example 68 | ∘ | 7 | 99 |
| Example 69 | ∘ | 3 | 61 |
| Example 70 | ∘ | 6 | 99 |
| Example 71 | ∘ | 5 | 99 |
| Example 72 | ∘ | 6 | 99 |

As shown in Table 8, the following has been found. Each of the resin-formed screen printing masks of Examples 41 to 72 is a resin-formed screen printing mask that is made by forming a resin layer and a masking layer on the first surface of a screen printing mask having openings, and supplying a resin layer-removing liquid from the second surface opposite to the first surface of the screen printing mask to remove the resin layer on the openings in the first surface and peripheries of the openings by self-alignment, a photo-crosslinkable resin composition containing a carboxyl group-containing binder polymer (A), a photopolymerizable compound (B) having at least one polymerizable ethylenically unsaturated group in its molecule and a photopolymerization initiator (C) is used as a material for constituting the resin layer, and the resin layer is treated for imparting it with durability after the resin layer on the openings in the first surface and peripheries of the openings is removed by self-alignment, whereby not only excellent openings without any positional deviation are formed in/through the resin layer, but also excellent capability of continuous printing can be obtained without cracking, breaking, swelling, etc., of the resin layer in the cleaning.

When Example 61 and Examples 69 to 72 are compared, it is seen that the resin layer is improved in solvent resistance and capability of continuous printing by treating the resin layer to impart it with durability by heat treatment after the application of ultraviolet ray. When carried out at 120° C. for 30 minutes, the effect of the heat treatment has been confirmed, and when it was carried out at 150° C. or 170° C., the crosslinking density of the resin layer was further increased and the resin layer was improved in solvent resistance and capability of continuous printing.

When Examples 41 to 46 are compared, it is seen that when a photopolymerizable compound having at least 3 polymerizable ethylenically unsaturated groups in its molecule is incorporated as a component (B) in an amount of 20 to 60% by mass based on the total amount of the components (A) and (B) and in an amount of 60% by mass or more based on the total amount of the component (B), excellent solvent resistance and capability of excellent continuous printing can be obtained.

When Examples 46 to 53 are compared, it is seen that when at least one of trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa meth)acrylate and trimethylolpropane triglycidyl ether tri(meth)acrylate is incorporated as a photopolymerizable compound having at least 3 polymerizable ethylenically unsaturated groups in its molecule, in particular, excellent solvent resistance and capability of excellent continuous printing can be obtained. Further, when a photopolymerizable compound having at least 3 polymerizable ethylenically unsaturated groups in its molecule is used and when it contains a polyalkylene oxide group in its structure, a resin layer is poor in solvent resistance and capability of continuous printing as compared with a case where it contains no polyoxyalkylene oxide group.

When Examples 46 and Examples 54 to 60 are compared, it is seen that when a binder polymer having a carboxyl group, which has a polymerizable ethylenically unsaturated group in its molecule and has its double bond equivalent weight of 400 to 3,000, is used as a component (A), solvent resistance and capability of continuous printing can be further improved. In Example 60, however, the resin layer was poor in shelf life, and the resin layer went crosslinked in a few days after the resin film was prepared and before the resin-formed screen-printing mask was made by removing the resin layer.

### INDUSTRIAL UTILITY

The method for making a resin-formed screen printing mask, provided by this invention, and the resin-formed screen printing mask of this invention can be applied to a broad range of use of screen printing, and for example, they can be applied to the use field where a pattern of an electrically conductive material, an insulating material, a colorant, a sealing material, an adhesive material, a resist material, a treatment chemical, or the like as a paste material is formed on any substrate by screen printing.

1. A method for making a resin-formed screen printing mask having a resin layer on one main surface of a screen printing mask having openings, the resin layer having openings nearly in the same locations as those of said openings of the screen printing mask,
the method comprising the step of coating the one main surface of said screen printing mask with the resin layer by laminating, and
the step of removing those parts of said resin layer which are positioned nearly in the same locations as those of the openings of said screen printing mask by self-alignment, to form the openings through the resin layer.

2. The method for making a resin-formed screen printing mask according to claim 1, wherein said screen printing mask having openings is one selected from a metal mask made by an additive method, a metal mask made by a laser method, a metal mask made by an etching method, a mesh mask, a suspended mask and a solid mask.

3. The method for making a resin-formed screen printing mask according to claim 1, wherein said resin layer is formed from a photo-crosslinkable resin.

4. The method for making a resin-formed screen printing mask according to claim 3, wherein the photo-crosslinkable resin contains (A) a carboxyl group-containing binder polymer, (B) a photopolymerizable compound having at least one polymerizable ethylenically unsaturated group in its molecule and (C) a photopolymerization initiator.

5. The method for making a resin-formed screen printing mask according to claim 1, wherein said step of removing parts of the resin layer by self-alignment is practiced by supplying a resin layer-removing liquid from the other main surface that the screen printing mask has opposite to the main surface on which the resin layer is formed.

6. The method for making a resin-formed screen printing mask according to claim 1, which further comprises the step of forming an electrodeposition resin layer on the resin layer after the step of coating one main surface of said screen printing mask with the resin layer but before the step of forming the openings through the resin layer,
wherein said electrodeposition resin layer is coated on the resin layer excluding those parts of said resin layer which are positioned nearly in the same locations as those of openings of said screen printing mask, and
the step of removing parts of said resin layer by self-alignment is practiced by supplying a resin layer-removing liquid from the one main surface of said screen printing mask on which the resin layer and the electrodeposition layer are formed.

7. The method for making a resin-formed screen printing mask according to claim 1, wherein the step of removing parts of said resin layer by self-alignment is practiced by supplying a resin layer-removing liquid after those parts of said resin layer which are positioned nearly in the same locations as those of openings of said screen printing mask are decreased in layer thickness.

8. The method for making a resin-formed screen printing mask according to claim 5, wherein the resin layer-removing liquid is an aqueous solution containing at least one selected from alkali metal carbonate, alkali metal phosphate, alkali metal hydroxide and alkali metal silicate.

9. The method for making a resin-formed screen printing mask according to claim 1, wherein the openings formed through the resin layer have a larger area than the openings of said screen printing mask.

10. The method for making a resin-formed screen printing mask according to claim 9, wherein the resin-formed screen printing mask obtained is a resin-formed screen printing mask in which
the openings of the screen printing mask and the openings of the resin layer have nearly like forms,
the openings of the resin layer have a larger area than the openings of the screen printing mask, and
when a distance from an edge portion of opening of the screen printing mask to an edge portion of the resin layer in the vicinity of said opening is taken as an offset width, an offset width of a portion having a small curvature radius in the contour of opening of the screen printing mask is smaller than an offset width of a portion having a larger curvature radius in the contour of opening of the screen printing mask.

11. A resin-formed screen printing mask made by the method according to claim 1.

12. The method for making a resin-formed screen printing mask according to claim 6, wherein the resin layer-removing liquid is an aqueous solution containing at least one selected from alkali metal carbonate, alkali metal phosphate, alkali metal hydroxide and alkali metal silicate.

13. The method for making a resin-formed screen printing mask according to claim 7, wherein the resin layer-removing liquid is an aqueous solution containing at least one selected from alkali metal carbonate, alkali metal phosphate, alkali metal hydroxide and alkali metal silicate.

14. The method for making a resin-formed screen printing mask according to claim 2, wherein the openings formed through the resin layer have a larger area than the openings of said screen printing mask.

15. The method for making a resin-formed screen printing mask according to claim 3, wherein the openings formed through the resin layer have a larger area than the openings of said screen printing mask.

16. The method for making a resin-formed screen printing mask according to claim 4, wherein the openings formed through the resin layer have a larger area than the openings of said screen printing mask.

17. The method for making a resin-formed screen printing mask according to claim 5, wherein the openings formed through the resin layer have a larger area than the openings of said screen printing mask.

18. The method for making a resin-formed screen printing mask according to claim 6, wherein the openings formed through the resin layer have a larger area than the openings of said screen printing mask.

19. The method for making a resin-formed screen printing mask according to claim 7, wherein the openings formed through the resin layer have a larger area than the openings of said screen printing mask.

20. The method for making a resin-formed screen printing mask according to claim 8, wherein the openings formed through the resin layer have a larger area than the openings of said screen printing mask.

21. A resin-formed screen printing mask made by the method according to claim 2.

22. A resin-formed screen printing mask made by the method according to claim 3.

23. A resin-formed screen printing mask made by the method according to claim 4.

24. A resin-formed screen printing mask made by the method according to claim 5.

25. A resin-formed screen printing mask made by the method according to claim 6.

26. A resin-formed screen printing mask made by the method according to claim 7.

27. A resin-formed screen printing mask made by the method according to claim 8.

28. A resin-formed screen printing mask made by the method according to claim 9.

29. A resin-formed screen printing mask made by the method according to claim 10.
